(19) United States
(12) Patent Application Publication
(10) Pub. No.: US 2026/0304432 A1
(43) Pub. Date: Oct. 1, 2026

(54) TECHNIQUES FOR HANDLING OVERLAPPING UPLINK TRANSMISSIONS USING ORTHOGONAL COVER CODING

(71) Applicant: QUALCOMM Incorporated, San Diego, CA (US)

(72) Inventors: Syed Hashim Ali SHAH, Littleton, MA (US); Alberto RICO ALVARINO, San Diego, CA (US)

(21) Appl. No.: 19/530,927

(22) Filed: Feb. 5, 2026

Related U.S. Application Data
(60) Provisional application No. 63/780,015, filed on Mar. 28, 2025.

(51) Int. Cl. H04W 72/21; H04L 5/00

(52) U.S. Cl. CPC H04W 72/21; H04L 5/0007

(57) ABSTRACT

This disclosure provides methods, components, devices and systems for techniques for handling overlapping uplink transmissions using orthogonal cover coding (OCC). A user equipment (UE) may receive control information that schedules an OCC physical uplink shared channel (PUSCH) transmission and occupies a first set of slots (referred to as a first OCC slot group or OCC group). The UE may receive a message that triggers uplink control information (UCI) to be sent via a physical uplink control channel (PUCCH) transmission. In some aspects, the PUCCH transmission and the PUSCH transmission may be at least partially overlapping with one another. Based on the overlap, the UE may determine whether to drop the first OCC group that includes the PUSCH transmission or whether to multiplex the UCI with the PUSCH transmission based on one or more rules associated with a transmission time of the PUCCH transmission relative to the PUSCH transmission.

### CROSS REFERENCE

The present Application for Patent claims priority to U.S. Provisional Patent Application No. 63/780,015 by SHAH et al., entitled “TECHNIQUES FOR HANDLING OVERLAPPING UPLINK TRANSMISSIONS USING ORTHOGONAL COVER CODING,” filed Mar. 28, 2025, which is assigned to the assignee hereof and which is hereby incorporated by reference in its entirety.

### FIELD OF DISCLOSURE

The present disclosure relates to wireless communication, for example, to systems, devices, methods, and techniques associated with techniques for handling overlapping uplink transmissions using orthogonal cover coding (OCC).

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a user equipment (UE) is described. The method may include receiving control signaling indicating a spreading configuration corresponding to an orthogonal cover code (OCC) for communications of one or more uplink channels, receiving control information that schedules a physical uplink shared channel (PUSCH) transmission that occupies a first set of slots including a first OCC group based on the OCC, receiving a message that triggers uplink control information (UCI) for a physical uplink control channel (PUCCH) transmission that occupies a second set of slots, where the second set of slots of the PUCCH transmission at least partially overlaps with the first set of slots of the PUSCH transmission, and determining, when the PUSCH transmission is in accordance with the OCC, whether to drop the first OCC group that includes the PUSCH transmission or to multiplex the UCI with the PUSCH transmission based on one or more rules associated with a transmission time of the PUCCH transmission relative to the PUSCH transmission.

A UE for wireless communications is described. The UE may include a processing system that includes processor circuitry and memory circuitry that stores code. The processing system may be configured to cause the UE to receive control signaling indicating a spreading configuration corresponding to an OCC for communications of one or more uplink channels, receive control information that schedules an PUSCH transmission that occupies a first set of slots including a first OCC group based on the OCC, receive a message that triggers UCI for a PUCCH transmission that occupies a second set of slots, where the second set of slots of the PUCCH transmission at least partially overlaps with the first set of slots of the PUSCH transmission, and determine, when the PUSCH transmission is in accordance with the OCC, whether to drop the first OCC group that includes the PUSCH transmission or to multiplex the UCI with the PUSCH transmission based on one or more rules associated with a transmission time of the PUCCH transmission relative to the PUSCH transmission.

Another UE for wireless communications is described. The UE may include means for receiving control signaling indicating a spreading configuration corresponding to an OCC for communications of one or more uplink channels, means for receiving control information that schedules an PUSCH transmission that occupies a first set of slots including a first OCC group based on the OCC, means for receiving a message that triggers UCI for a PUCCH transmission that occupies a second set of slots, where the second set of slots of the PUCCH transmission at least partially overlaps with the first set of slots of the PUSCH transmission, and means for determining, when the PUSCH transmission is in accordance with the OCC, whether to drop the first OCC group that includes the PUSCH transmission or to multiplex the UCI with the PUSCH transmission based on one or more rules associated with a transmission time of the PUCCH transmission relative to the PUSCH transmission.

A non-transitory computer-readable medium storing code for wireless communications is described. The code may include instructions executable by one or more processors to receive control signaling indicating a spreading configuration corresponding to an OCC for communications of one or more uplink channels, receive control information that schedules an PUSCH transmission that occupies a first set of slots including a first OCC group based on the OCC, receive a message that triggers UCI for a PUCCH transmission that occupies a second set of slots, where the second set of slots of the PUCCH transmission at least partially overlaps with the first set of slots of the PUSCH transmission, and determine, when the PUSCH transmission is in accordance with the OCC, whether to drop the first OCC group that includes the PUSCH transmission or to multiplex the UCI with the PUSCH transmission based on one or more rules associated with a transmission time of the PUCCH transmission relative to the PUSCH transmission.

In some examples of the method, UEs, and non-transitory computer-readable medium described herein, the message triggers at least two repetitions of the PUCCH transmission and the method, UEs, and non-transitory computer-readable medium may include further operations, features, means, or instructions for dropping the first OCC group that includes the PUSCH transmission based on the one or more rules, where the one or more rules indicate that the first OCC group that includes the PUSCH transmission may be dropped when the PUCCH transmission may be configured with the at least two repetitions and when the transmission time results in at least an initial PUCCH repetition being within a threshold duration of the PUSCH transmission and transmitting the UCI via the at least two repetitions of the PUCCH transmission in accordance with the one or more rules and based on dropping the first OCC group that includes the PUSCH transmission.

In some examples of the method, UEs, and non-transitory computer-readable medium described herein, the message triggers the PUCCH transmission without repetition and the PUCCH transmission overlaps with a first slot of the first OCC group, and the method, UEs, and non-transitory computer-readable medium may include further operations, features, means, or instructions for multiplexing the UCI of the PUCCH transmission with the PUSCH transmission in accordance with the OCC based on the one or more rules, where the one or more rules indicate that the UCI may be multiplexed with the PUSCH transmission when the PUCCH transmission may be configured without repetition and when the transmission time results in the PUCCH transmission being within a threshold duration of the first slot of the first OCC group.

In some examples of the method, UEs, and non-transitory computer-readable medium described herein, the message triggers the PUCCH transmission without repetition and the PUCCH transmission overlaps with a second slot of the first OCC group, and the method, UEs, and non-transitory computer-readable medium may include further operations, features, means, or instructions for dropping the first OCC group that includes the PUSCH transmission based on the one or more rules, where the one or more rules indicate that the first OCC group that includes the PUSCH transmission may be dropped when the PUCCH transmission may be configured without repetitions and when the transmission time results in the PUCCH transmission being within a threshold duration of the PUSCH transmission and transmitting the UCI via the PUCCH transmission in accordance with the one or more rules and based on dropping the first OCC group that includes the PUSCH transmission.

In some examples of the method, UEs, and non-transitory computer-readable medium described herein, the message triggers the PUCCH transmission without repetition and the PUCCH transmission overlaps with a second slot that is different from a first slot of the first OCC group, and the method, UEs, and non-transitory computer-readable medium may include further operations, features, means, or instructions for multiplexing the UCI of the PUCCH transmission with the PUSCH transmission of the first OCC group based on the one or more rules, where the one or more rules indicate that the UCI may be multiplexed with the PUSCH when the PUCCH transmission may be configured without repetition and when the transmission time results in the PUCCH transmission being within a threshold duration of the second slot of the first OCC group.

In some examples of the method, UEs, and non-transitory computer-readable medium described herein, the message triggers the PUCCH transmission without repetition, and the PUCCH transmission overlaps with a second OCC group that occurs after the first OCC group, and the method, UEs, and non-transitory computer-readable medium may include further operations, features, means, or instructions for dropping the at least one additional OCC group, the first OCC group, or both, that include the PUSCH transmission based on the one or more rules, where the one or more rules indicate that the at least the additional OCC slot, the first OCC group, or both may be dropped when the PUCCH transmission may be configured without repetition and when the transmission time results in the PUCCH transmission being within a threshold duration of the message and transmitting the UCI via the PUCCH transmission in accordance with the one or more rules and based on dropping the at least one additional OCC group, the first OCC group, or both, that include the PUSCH transmission.

In some examples of the method, UEs, and non-transitory computer-readable medium described herein, the message triggers the PUCCH transmission without repetition, and the PUCCH transmission overlaps with a second OCC group occurring after the first OCC group, and the method, UEs, and non-transitory computer-readable medium may include further operations, features, means, or instructions for dropping the at least one additional OCC group, the first OCC group, or both, that include the PUSCH transmission based on the one or more rules, where the one or more rules indicate that the at least the additional OCC group, the first OCC group, or both, may be dropped when the PUCCH transmission may be configured without repetition and when the transmission time results in the first OCC group including the PUSCH transmission may be within a threshold duration of the message and transmitting the UCI via the PUCCH transmission in accordance with the one or more rules and based on dropping the at least one additional OCC group, the first OCC group, or both, that include the PUSCH transmission.

In some examples of the method, UEs, and non-transitory computer-readable medium described herein, during transmission of the PUSCH transmission, the UE receives the message that triggers the UCI of the PUCCH transmission, and the method, UEs, and non-transitory computer-readable medium may include further operations, features, means, or instructions for dropping one or more OCC groups that include the PUSCH transmission based on reception of the message, dropping the PUCCH transmission based on reception of the message during transmission of the PUSCH transmission, and dropping both the PUCCH transmission and the one or more OCC groups that include the PUSCH transmission.

Some examples of the method, UEs, and non-transitory computer-readable medium described herein may further include operations, features, means, or instructions for transmitting one or more UE capability messages indicative of an OCC capability of the UE, a phase coherence capability of the UE, a capability of the UE to support transmission of PUSCH and PUCCH in accordance with the transmission time, or any combination thereof.

In some examples of the method, UEs, and non-transitory computer-readable medium described herein, the transmission time includes a processing time that occurs between reception of the message and the PUCCH transmission, a processing time between reception of the control message and transmission of the PUSCH transmission, or both and determining whether to drop the first OCC group that includes the PUSCH transmission or to multiplex the UCI with the PUSCH transmission may be further based on whether the transmission time exceeds a threshold duration.

A method for wireless communications at a network entity is described. The method may include outputting control signaling indicating a spreading configuration corresponding to an orthogonal cover coding (OCC) for communications of one or more uplink channels, outputting control information that schedules an PUSCH transmission that occupies a first set of slots including a first OCC group based on the OCC, outputting a message that is associated with UCI for a PUCCH transmission that occupies a second set of slots, where the second set of slots of the PUCCH transmission at least partially overlaps with the first set of slots of the PUSCH transmission, and determining, when the PUSCH transmission is in accordance with the OCC, whether to receive the UCI multiplexed with the PUSCH transmission, or whether to expect reception of the PUCCH transmission without reception of the PUSCH transmission based on one or more rules associated with a transmission time of the PUCCH transmission relative to the PUSCH transmission.

An network entity for wireless communications is described. The network entity may include a processing system that includes processor circuitry and memory circuitry that stores code. The processing system may be configured to cause the network entity to output control signaling indicating a spreading configuration corresponding to an orthogonal cover coding (OCC) for communications of one or more uplink channels, output control information that schedules an PUSCH transmission that occupies a first set of slots including a first OCC group based on the OCC, output a message that is associated with UCI for a PUCCH transmission that occupies a second set of slots, where the second set of slots of the PUCCH transmission at least partially overlaps with the first set of slots of the PUSCH transmission, and determine, when the PUSCH transmission is in accordance with the OCC, whether to receive the UCI multiplexed with the PUSCH transmission, or whether to expect reception of the PUCCH transmission without reception of the PUSCH transmission based on one or more rules associated with a transmission time of the PUCCH transmission relative to the PUSCH transmission.

Another network entity for wireless communications is described. The network entity may include means for outputting control signaling indicating a spreading configuration corresponding to an orthogonal cover coding (OCC) for communications of one or more uplink channels, means for outputting control information that schedules an PUSCH transmission that occupies a first set of slots including a first OCC group based on the OCC, means for outputting a message that is associated with UCI for a PUCCH transmission that occupies a second set of slots, where the second set of slots of the PUCCH transmission at least partially overlaps with the first set of slots of the PUSCH transmission, and means for determining, when the PUSCH transmission is in accordance with the OCC, whether to receive the UCI multiplexed with the PUSCH transmission, or whether to expect reception of the PUCCH transmission without reception of the PUSCH transmission based on one or more rules associated with a transmission time of the PUCCH transmission relative to the PUSCH transmission.

A non-transitory computer-readable medium storing code for wireless communications a network entity is described. The code may include instructions executable by one or more processors to output control signaling indicating a spreading configuration corresponding to an orthogonal cover coding (OCC) for communications of one or more uplink channels, output control information that schedules an PUSCH transmission that occupies a first set of slots including a first OCC group based on the OCC, output a message that is associated with UCI for a PUCCH transmission that occupies a second set of slots, where the second set of slots of the PUCCH transmission at least partially overlaps with the first set of slots of the PUSCH transmission, and determine, when the PUSCH transmission is in accordance with the OCC, whether to receive the UCI multiplexed with the PUSCH transmission, or whether to expect reception of the PUCCH transmission without reception of the PUSCH transmission based on one or more rules associated with a transmission time of the PUCCH transmission relative to the PUSCH transmission.

In some examples of the method, network entities, and non-transitory computer-readable medium described herein, the message may be associated with at least two repetitions of the PUCCH transmission and the method, network entities, and non-transitory computer-readable medium may include further operations, features, means, or instructions for obtaining the UCI via the at least two repetitions of the PUCCH transmission in accordance with the one or more rules, where the one or more rules indicate that the first OCC group that includes the PUSCH transmission may be dropped when the PUCCH transmission may be configured with the at least two repetitions and when the transmission time results in at least an initial PUCCH repetition being within a threshold duration of the PUSCH transmission.

In some examples of the method, network entities, and non-transitory computer-readable medium described herein, the message may be associated with the PUCCH transmission without repetition, and the PUCCH transmission overlaps with a first slot of the first OCC group, and the method, network entities, and non-transitory computer-readable medium may include further operations, features, means, or instructions for obtaining the UCI multiplexed with the PUSCH transmission in accordance with the OCC based on the one or more rules, where the one or more rules indicate the UCI may be multiplexed with the PUSCH transmission when the PUCCH transmission may be configured without repetition and when the transmission time results in the PUCCH transmission being within a threshold duration of the first slot of the first set of slots of the PUSCH transmission.

In some examples of the method, network entities, and non-transitory computer-readable medium described herein, the message may be associated with the PUCCH transmission without repetition and the PUCCH transmission overlaps with a second slot of the first set of slots of the PUSCH transmission, and the method, network entities, and non-transitory computer-readable medium may include further operations, features, means, or instructions for obtaining the UCI via the PUCCH transmission in accordance with the one or more rules, where the one or more rules indicate that the first OCC group that includes the PUSCH transmission may be dropped when the PUCCH transmission may be configured without repetitions and when the transmission time results in the PUCCH transmission being within a threshold duration of the PUSCH transmission.

In some examples of the method, network entities, and non-transitory computer-readable medium described herein, the message may be associated with the PUCCH transmission without repetition and the PUCCH overlaps with a second slot that is different from a first slot of the first slot of the first OCC group, and the method, network entities, and non-transitory computer-readable medium may include further operations, features, means, or instructions for obtaining the UCI multiplexed with the PUSCH transmission in accordance with the OCC of the first OCC group based on the one or more rules, where the one or more rules indicate that the UCI may be multiplexed with the PUSCH when the PUCCH transmission may be configured without repetition and when the transmission time results in the PUCCH transmission being within a threshold duration of the second slot of the first OCC group.

In some examples of the method, network entities, and non-transitory computer-readable medium described herein, the message may be associated with the PUCCH transmission without repetition and the PUCCH transmission overlaps with a second OCC group that occurs after the first OCC group, and the method, network entities, and non-transitory computer-readable medium may include further operations, features, means, or instructions for obtaining the UCI via the PUCCH transmission in accordance with the one or more rules, where the one or more rules indicate that the PUSCH transmission in the at least the additional OCC group, the first OCC group, or both, may be dropped when the PUCCH transmission may be configured without repetition and when the transmission time results in the PUCCH transmission being within a threshold duration of the message.

In some examples of the method, network entities, and non-transitory computer-readable medium described herein, the message may be associated with the PUCCH transmission without repetition and the PUCCH transmission overlaps with a second OCC group occurring after the first OCC group, and the method, network entities, and non-transitory computer-readable medium may include further operations, features, means, or instructions for obtaining the UCI via the PUCCH transmission based on the one or more rules, where the one or more rules indicate that the at least the additional OCC group, the first OCC group, or both, may be dropped when the PUCCH transmission may be configured without repetition and when the transmission time results in the first OCC group including the PUSCH transmission may be within a threshold duration of the message.

Some examples of the method, network entities, and non-transitory computer-readable medium described herein may further include operations, features, means, or instructions for modifying a first scheduling of the message associated with the UCI of the PUCCH transmission based on the first scheduling indicating that the message may be at least partially overlapping with the PUSCH transmission.

Some examples of the method, network entities, and non-transitory computer-readable medium described herein may further include operations, features, means, or instructions for obtaining one or more UE capability messages indicative of an OCC capability of the UE, a phase coherence capability of the UE, a capability of the UE to support transmission of PUSCH and PUCCH in accordance with the transmission time, or any combination thereof.

In some examples of the method, network entities, and non-transitory computer-readable medium described herein, the transmission time includes a processing time that occurs between reception of the message and the PUCCH transmission, a processing time between reception of the control message and transmission of the PUSCH transmission, or both and determining whether to drop the first OCC group that includes the PUSCH transmission or to multiplex the UCI with the PUSCH transmission may be further based on whether the transmission time exceeds a threshold duration.

### BRIEF DESCRIPTION OF THE DRAWINGS

FIG. 1 shows an example of a wireless communication system.

FIG. 2 shows an example of a signaling diagram that supports techniques for handling overlapping uplink transmissions using orthogonal cover coding (OCC).

FIG. 3 shows an example of a flow diagram that supports techniques for handling overlapping uplink transmissions using OCC.

FIG. 4 shows examples of a dropping rule and a multiplexing rule that supports techniques for handling overlapping uplink transmissions using OCC.

FIG. 5 shows examples of a dropping rule and a multiplexing rule that supports techniques for handling overlapping uplink transmissions using OCC.

FIG. 6 shows an example of a examples of a dropping rule and an error case rule that supports techniques for handling overlapping uplink transmissions using OCC.

FIG. 7 shows an example of a process flow that supports techniques for handling overlapping uplink transmissions using OCC.

FIG. 8 shows a block diagram of a processing system that supports techniques for handling overlapping uplink transmissions using OCC.

FIG. 9 shows a diagram of a system including a device that supports techniques for handling overlapping uplink transmissions using OCC.

FIG. 10 shows a block diagram of a processing system that supports techniques for handling overlapping uplink transmissions using OCC.

FIG. 11 shows a diagram of a system including a device that supports techniques for handling overlapping uplink transmissions using OCC.

FIGS. 12 and 13 show flowcharts illustrating methods that support techniques for handling overlapping uplink transmissions using OCC.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, multiple user equipment (UEs) may simultaneously access resources using multiple access schemes, in which data from the multiple UEs is identified at a network entity, and multiple UEs may utilize the same time-frequency resources. In some multiple access schemes scenarios, however, the simultaneous transmissions from the multiple UEs may cause uplink interference at the network entity, and may result in decoding complexities. To effectively mitigate interference, some UEs may use orthogonal cover coding (OCC) to encode uplink data transmissions (such as physical uplink shared channel (PUSCH) transmissions), so that multiple UEs (e.g., messages from multiple UEs) may be multiplexed on the same resources. For example, multiple UEs may transmit PUSCH (e.g., data transmissions) by cover coding data over multiple repetitions in an orthogonal manner using OCC.

Some wireless communications systems may support OCCs to enable orthogonal M order UE multiplexing (without robust scrambling and/or complex receiver design at the network entity). That is, UEs may apply the M factor cover coding (where PUSCH transmissions are spread over M slots using OCC) without increasing the amount of time-frequency resources used for the uplink transmissions, so that uplink capacity is increased in terms of the quantity of UEs that can be scheduled in a given time-frequency resource, with almost no interference among the UEs. In some cases, however, there may be scheduling conflicts between other uplink transmissions and a PUSCH that is subject to OCC. For example, a PUSCH may at least partially overlap with transmissions of a physical uplink control channel (PUCCH), which is used to transmit control information such as uplink control information (UCI), including hybrid automatic repeat request (HARQ) feedback, channel state information (CSI) and scheduling requests. In some cases, UCI may be transmitted via PUCCH or by PUSCH, for example, in cases of PUSCH and PUCCH overlap, the UCI may be multiplexed onto the PUSCH. Additionally, or alternatively, in some cases of PUCCH and PUSCH overlap, PUSCH symbols or PUCCH symbols that are overlapping may be dropped (e.g., based on transmission priority or priority index).

In some aspects, the UE may determine whether to multiplex the information included in the PUCCH (e.g., the UCI) with the PUSCH transmission (that is subject to OCC) based on various factors. For example, the UE 115 may receive a “PUCCH triggering event,” or an event that triggers scheduling and transmission of a PUCCH or UCI, which may schedule repetitions of the PUCCH or may schedule a single PUCCH transmission. In such cases of PUCCH overlap with OCC PUSCH, the UE may utilize one or more rules to determine whether to multiplex and OCC the PUCCH (e.g., UCI of the PUCCH) with the OCC PUSCH, or whether to drop one or more OCC groups that include the PUSCH.

In some examples, if a PUCCH with two or more repetitions overlaps a PUSCH with OCC, the UE may drop the OCC group that includes the PUSCH in favor of transmitting the PUCCH if the time difference between the PUCCH triggering event and start of PUSCH transmission satisfies a threshold. In some examples, if the PUCCH is scheduled without repetitions and overlaps a first slot of PUSCH with OCC, the UE may multiplex the UCI with the PUSCH and apply OCC to the UCI if the time difference between the PUCCH trigger event and start of PUSCH transmission satisfies a threshold. In some examples, if a PUCCH is scheduled without repetitions and overlaps a second slot (e.g., not a first slot) of PUSCH with OCC, the UE may drop the OCC group that includes the PUSCH and transmit the PUCCH (or multiplex the UCI with the PUSCH) if the time difference between the PUCCH trigger and start of PUSCH transmission satisfies a threshold. In some examples, if a PUCCH is scheduled without repetitions and overlaps a first slot of PUSCH of a second OCC group, the UE may drop the second OCC group that includes the PUSCH and may transmit the PUCCH if the time difference between the PUCCH trigger and start of PUSCH transmission (of the first or second OCC group) satisfies a threshold.

Aspects of the subject matter described in this disclosure can be implemented to realize one or more of the following potential advantages. In some examples, by applying the one or more rules described herein, the described techniques can be used to improve coordination between a UE and a network entity that support communications of uplink data using OCC. For example, based on the establishment of the rules as described herein, the UE may be able to determine how to effectively transmit UCI (e.g., via PUCCH or via PUSCH with OCC) and the network may correspondingly be able to predict when and where the UCI will be received. Additionally, or alternatively, the techniques described herein may allow for more efficient application and handling of OCC for PUSCH when scheduling conflicts occur. For example, the UE may determine when multiplexing UCI with PUSCH is compatible with OCC, and when the PUSCH is to be dropped based on incompatibility. Additionally, or alternatively, the techniques described herein may allow for more reliable communication of UCI when scheduling conflicts between PUCCH and PUSCH with OCC occur.

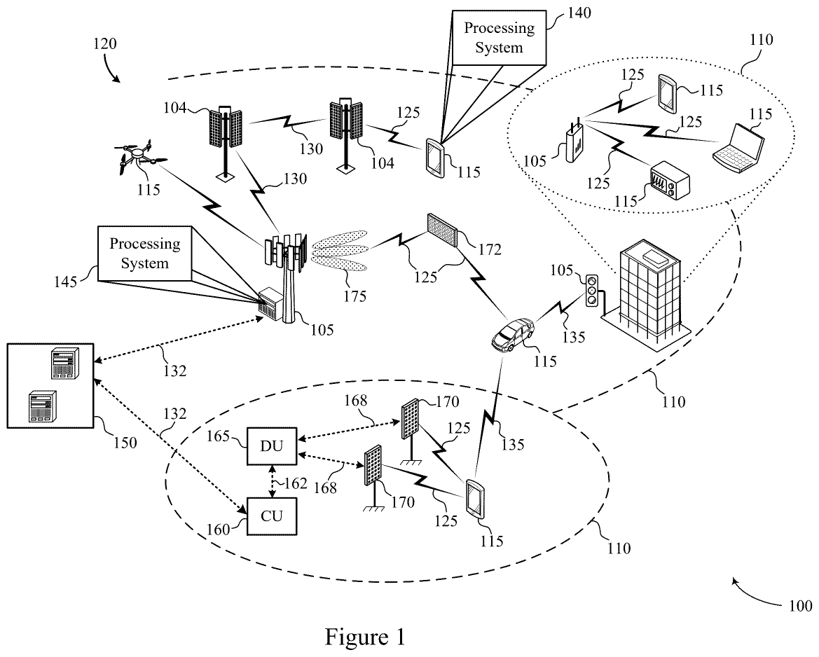

FIG. 1 shows an example of a wireless communication system 100. The wireless communication system 100 includes a core network 150 and a RAN 120 that support communication with one or more devices, such as UEs 115 in accordance with various aspects of the present disclosure. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with an orientation (such as relative to the antenna array of the device).

In some examples, the wireless communication system 100 may use a non-terrestrial device, a non-terrestrial network (NTN), or an aerial platform to support a coverage area 110. NTNs may be examples of networks or segments of networks that utilize non-terrestrial devices (e.g., satellites, aerial platforms) to support communication between network entities 105 and UEs 115. A satellite may be deployed in a variety of orbits to support an NTN, including a low earth orbit (LEO), a medium earth orbit (MEO), a geostationary earth orbit (GEO), a highly elliptical orbit (HEO), or any combination thereof. An aerial platform, such as an unmanned aerial vehicle (UAV) or a high altitude platform (HAP), may be an example of a network entity 105, a UE 115, or both operating above the ground, and the aerial platform can be capable of moving within a geographic area or between geographic areas. In some examples, the wireless communication system 100 may use satellites and aerial platforms to extend the coverage of a coverage area 110. For example, the wireless communication system 100 may implement one or more satellites, one or more aerial platforms, or both to increase the size of a coverage area 110 by supporting additional geographic areas over which a network entity 105 and a UE 115 may support the communication of signals according to one or more RATs.

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a PUSCH for communicating user data in an uplink direction. Physical control channels (such as for managing communication via physical channels) may include a physical downlink control channel (PDCCH) for communicating downlink control information (DCI) and a physical uplink control channel (PUCCH) for communicating UCI. A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

To increase uplink capacity, multiple UEs may simultaneously access resources using multiple access schemes such as non-orthogonal multiple access (NOMA), in which data from the multiple UEs is identified at a network entity of the network, and multiple UEs may utilize the same time-frequency resources. In some multiple access schemes scenarios, the simultaneous transmissions from the multiple UEs may cause uplink interference at the network entity. Moreover, identifying the data at the network entity as coming from different UEs may be complex and time consuming. For example, identifying data from respective UEs may involve the UEs employing complex and robust scrambling schemes and complex receiver design at the network entity.

UEs may effectively mitigate interference by using OCC to encode PUSCH transmissions, so that multiple UEs may be multiplexed on the same time resources. For example, multiple UEs may transmit PUSCH (e.g., data transmissions) by cover coding data over multiple repetitions (e.g., transport block processing over multiple slots (TBoMs)) in an orthogonal manner using OCC, and each UE may achieve coverage enhancement from repetition. The repetition nature of the uplink transmissions allows the network to support OCC without increased complexity. In some aspects, OCC may be supported by an OFDM grid structure of time resources (e.g., with different resource allocation types and TBoMS). In some examples, a UE 115 may apply OCC to discrete Fourier transform-spread-OFDM (DFT-s-OFDM) PUSCH, among other types of PUSCH or data transmissions. In addition, the UE 115 may apply OCC across OFDM symbols, across slots, and/or within an OFDM symbol or multiple OFDM symbols.

In some aspects, PUSCH transmission with OCC may allow for PUSCH transmission with repetition without sacrificing resource efficiency due to repetition. Specifically, multiple UEs can transmit PUSCH transmissions on a time/frequency resource with minimal performance degradation (e.g., performance degradation that is below a threshold degradation), and while obtaining coverage enhancement from the repetition.

An OCC scheme (such as an intra-slot OCC scheme, or an inter-slot OCC scheme) may be implemented across OFDM symbols or slots. For example, the UEs 115 (e.g., a transmitting device) may receive all the data symbols from the output of modulator, select the OCC codeword (e.g., a row of a Hadamard matrix), which may be indicated in control signaling received from a network entity 105, or autonomously selected, perform an M factor cover coding of symbols using OCC, and transmit the OCC-configured data. The network entity 105 may receive the OCC-configured data symbols, decode the OCC for the corresponding UE 115 (e.g., using the corresponding Hadamard matrix), and send the decoded sequence to a demodulator for calculations (e.g., log-likelihood ratio (LLR) calculations). The OCC may be performed on a symbol-wise or slot-wise basis (e.g., symbol-by-symbol or slot-by-slot).

A UE may apply an OCC in order to spread one slot into M slots, where OCC may be applied to generate orthogonal transmissions for two or more UEs. For transmissions from two UEs, a first UE 115 may input a first encoded slot

$${S}_{1}^{0}$$

(where S

$${S}_{i}^{j}$$

corresponds to a slot j at UE i) to an OCC matrix and a second UE 115 may input a second encoded slot

$${S}_{2}^{0}$$

to the OCC matrix. In some examples, the OCC matrix may be a 2×2 matrix (e.g., two rows and two columns). For example, the OCC matrix may be a Hadamard matrix, an identity matrix, a DFT matrix or any other orthogonal matrix. In OCC, each row or column of the OCC matrix may be used as a codeword. To be compatible with OCC, each row or column of a matrix may be orthogonal. For example, for the OCC matrix, the first row may correspond to a vector [1,1] that, when given as an input the first slot, outputs a product including two spread slots

$$( e . g . , {S}_{1}^{0} , and {S}_{1}^{0} )$$

that have the same values as the input of the first encoded slot. The second row of the OCC matrix may correspond to a vector of [1, −1]. The second row, when given the second encoded slot

$${S}_{2}^{0}$$

as an input, outputs a product including two respective spread slots

$$( e . g . , {S}_{2}^{0} , - {S}_{2}^{0} )$$

including a slot with a same value as the input slot, and a negative output of the input slot. Applying the matrix in this manner to the input slots produces orthogonal outputs, and accordingly, transmissions from the first UE 115 and the second UE 115 are orthogonal and therefore do not interfere with each other.

In some examples, for four UEs 115, the matrix may be a 4×4 Hadamard matrix having four rows and four columns. In such examples, the matrix may include a first row vector of [1, 1, 1, 1], a second row vector of [1, −1, 1, −1], a third row vector [1, 1, −1, −1], and a fourth row vector [1, −1, −1, 1]. As described herein, although an OCC matrix with row vectors [1,1] and [1,−1] is used as an example for multiplexing two UEs 115 for M=2, an OCC matrix with row vectors of [1, 1, 1, 1], [1, −1, 1, −1], [1, 1, −1, −1], and [1, −1, −1, 1] may be used for multiplexing four UEs 115, and any orthogonal matrix may be used as an OCC matrix for multiplexing any quantity of UEs 115. For example, any orthogonal 2×2 matrix may be used to multiplex two UEs 115 in OCC, any orthogonal 3×3 matrix may be used to multiplex three UEs 115 in OCC, any orthogonal 4×4 matrix may be used to multiplex four UEs 115 in OCC, and so on.

Devices of the wireless communication system 100 may be configured to support one or more aspects of the described techniques for techniques for handling overlapping uplink transmissions using OCC. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the wireless communication system 100 (such as the RAN 120) may support OCC techniques as described herein.

In some aspects, a UE 115 may implement one or more rules to determine whether to multiplex the information included in a PUCCH (e.g., UCI) with a PUSCH transmission (that is subject to OCC), or whether to drop an OCC group that includes the PUSCH transmissions when scheduling overlaps between the PUSCH and the PUCCH occur.

In some examples, if a PUCCH with two or more repetitions overlaps a PUSCH with OCC, the UE 115 may drop the OCC group that includes the PUSCH in favor of transmitting the PUCCH if the time difference between the PUCCH triggering event and start of PUSCH transmission satisfies a threshold. In some examples, if the PUCCH is scheduled without repetitions and overlaps a first slot of PUSCH with OCC, the UE 115 may multiplex the UCI with the PUSCH and apply OCC to the UCI if the time difference between the PUCCH trigger event and start of PUSCH transmission satisfies a threshold. In some examples, if a PUCCH is scheduled without repetitions and overlaps a second slot (e.g., not a first slot) of PUSCH with OCC, the UE 115 may drop the OCC group that includes the PUSCH and transmit the PUCCH (or multiplex the UCI with the PUSCH) if the time difference between the PUCCH trigger and start of PUSCH transmission satisfies a threshold. In some examples, if a PUCCH is scheduled without repetitions and overlaps a first slot of PUSCH of a second OCC group, the UE 115 may drop the second OCC group that includes the PUSCH and may transmit the PUCCH if the time difference between the PUCCH trigger and start of PUSCH transmission (of the first or second OCC group) satisfies a threshold.

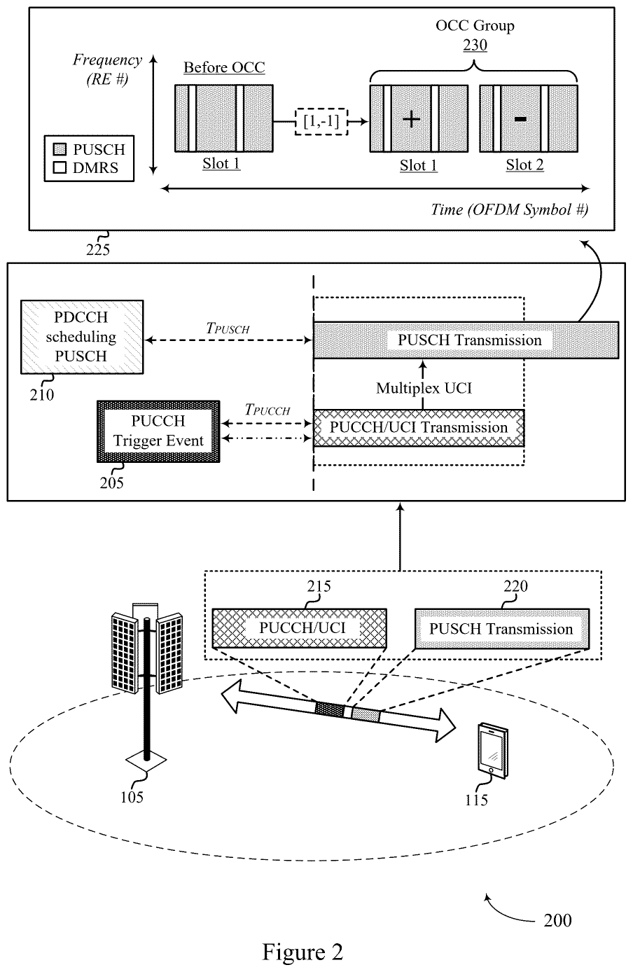

FIG. 2 shows an example of a signaling diagram 200 that supports techniques for handling overlapping uplink transmissions using OCC in accordance with various aspects of the present disclosure. For example, the signaling diagram 200 may support communications of uplink channel transmissions (such as PUCCH including UCI, and PUSCH) and downlink channel transmissions (such as PDSCH and PDCCH) between a UE 115 and a network entity 105, each of which may be examples of UEs 115 and network entities 105 described herein. In some examples, the UE 115 and the network entity may support communications using OCC.

Some wireless communications systems may support OCCs to enable orthogonal M order UE multiplexing (without robust scrambling and/or complex receiver design at the network entity). That is, UEs may apply the M factor cover coding (where M indicates the quantity of uplink transmissions from different UEs that are multiplexed over the same time-frequency resources) without increasing the amount of time-frequency resources used for the uplink transmissions, so that uplink capacity (in terms of the quantity of UEs that can be scheduled in a given time-frequency resource, with almost no interference among the UEs) may be increased. The UE 115 and the network entity 105 may support slot-level OCC is supported for uplink shared channel transmissions (e.g., physical uplink shared channel (PUSCH) transmissions), such that PUSCH transmissions can be spread over M slots using OCC codewords. In some cases, however, there may be scheduling conflicts between other uplink transmissions and a PUSCH that is subject to OCC. For example, a PUSCH may at least partially overlap with transmissions of a physical uplink control channel (PUCCH), which is used to transmit control information such as uplink control information (UCI), including HARQ feedback (ACK/NACK), CSI and scheduling requests. In some cases, UCI (which may include one or more types of UCI) may be transmitted via PUCCH or by PUSCH, for example, in cases of PUSCH and PUCCH overlap, the UCI may be multiplexed onto the PUSCH (e.g., the UE 115 may puncture or drop some of the data of the PUSCH in order to multiplex the UCI onto the PUSCH). Additionally, or alternatively, in some cases of PUCCH and PUSCH overlap, PUSCH symbols or PUCCH symbols that are overlapping may be dropped (e.g., based on transmission priority or priority index value).

In some cases, the UE 115 may determine whether to multiplex the information included in the PUCCH (e.g., the UCI) with the PUSCH transmission (that is subject to OCC) based on the timing of transmission and reception of uplink and downlink communications. For example, the UE 115 may receive a downlink transmission (e.g., a scheduling request, a PDSCH, or a DCI) that requires ACK/NACK which may be referred to as a “PUCCH triggering event 205,” or an event that triggers scheduling and transmission of a PUCCH transmission 215 or UCI, or schedules transmission of a channel state information (CSI) report (in some cases, CSI may be carried in UCI that may be multiplexed onto the PUSCH). In some examples, when the UE 115 receives the PUCCH triggering event 205, the UE 115 may take time T_{PUCCH} to process the PUCCH triggering event 205 prior to transmission of the PUCCH transmission 215. Similarly, the UE 115 may receive PDCCH 210 (such as an uplink grant DCI) that schedules the UE to 115 to transmit the PUSCH transmission 220, the UE 115 may take time T_{PUSCH} to process and prepare the PUSCH transmission 220. In some cases, the PUSCH transmission 220 may at least partially overlap with the PUCCH transmission 215. In such cases, if the time difference between the PUCCH triggering event 205 and the start of the PUSCH transmission 220 meets a criteria (e.g., if the time difference satisfies a threshold duration or is sufficient for the UE 115 to process and prepare the PUCCH transmission 215), then the UE 115 may multiplex the UCI of the PUCCH transmission 215 on the PUSCH transmission 220, and may drop the PUCCH based on the multiplexing.

The PUSCH transmission 220 may be cover coded using OCC using the OCC process 225, where prior to OCC, the PUSCH transmission 220 may occupy a single slot (e.g., Slot 1) with DMRS. For M=2 transmissions from two UEs, the UE 115 may input a first encoded slot (e.g., slot 1) to an OCC matrix, where each row or column of the OCC matrix may be used as a codeword. To be compatible with OCC, each row or column of a matrix may be orthogonal. For example, for the OCC matrix, the UE 115 may use a row of the OCC matrix that may correspond to a vector of [1, −1]. When given slot 1 as an input, outputs a product including two respective spread slots (e.g., slot 1, slot 2), where slot 1 is a slot with a same value as the input slot, and slot 2 is a negative output of slot 1, and the combination of slot 1 and slot 2 may be referred to as an OCC slot group 230 (or just “an OCC group,” where PUSCH transmissions are spread over M slots using OCC code words, and a group of M slots may be referred to as an OCC group). In some examples, another UE 115 may be multiplexed with a row of the OCC matrix that corresponds to a vector [1,1]. When given slot 1 as an input, a product may be output that includes two respective spread slots (e.g., slot 1, slot 2), where slot 1 is a slot with a same value as the input slot, and slot 2 is also has the same value as the input slot, Applying the matrix in this manner to the input slots produces orthogonal outputs, and accordingly, transmissions from the first UE 115 and the second UE 115 (e.g., M=2) are orthogonal and therefore do not interfere with each other. In some examples, an OCC group (also referred to as an “OCC slot group”) includes L consecutive PUSCH repetitions, where L represents the OCC length.

In some examples, the PUCCH transmission 215 may be at least partially overlapping with the PUSCH transmission 220 that is subject to the OCC (e.g., the PUCCH transmission 215 may be scheduled to be transmitted on the same time resources as the PUSCH transmission 220). In some cases, the PUCCH transmission 215 may carry information that has a higher priority (e.g., priority index) relative to the PUSCH transmission 220, and the UE 115 may utilize one or more rules in order to determine whether to drop the first OCC slot group that includes the PUSCH transmission 220, or whether to multiplex UCI of the PUCCH transmission 215 onto the PUSCH transmission 220. For example, if the PUCCH transmission 215 overlaps with first slot of the OCC group, the UE 115 may apply OCC to the PUCCH (e.g., the UCI) and may multiplex the OCC UCI with the PUSCH transmission 220, as long as a processing time is sufficient for the UE 115 to complete the processing and multiplexing. In some other examples, if the PUCCH transmission 215 overlaps with any other slot of the OCC group (e.g., not the first slot), then the UE 115 may be unable to apply OCC to the PUCCH transmission 215 and may drop the PUSCH transmission 220 in favor of transmitting the UCI via the PUCCH transmission 215.

In some examples, the UE 115 may inform the network entity 105 of one or more capabilities of the UE 115 to support OCC using UE capability signaling. For example, the UE 115 may transmit one or more UE capability messages that indicate that the UE 115 is capable of supporting at least one form of OCC. In some cases, the UE capability signaling for OCC may be based on one or more phase coherence capabilities associated with the UE 115. Additionally, or alternatively, the UE capability signaling may indicate a UE capability to transmit the PUCCH transmission 215, the PUSCH transmission 220, or both, according to one or more timelines described herein. In some examples, the network entity 105 may transmit (e.g., via radio resource control (RRC) signaling, medium access control-control element (MAC-CE), DCI, or other control signaling) an indication of an OCC configuration for the UE 115. For example, the network entity 105 may indicate the OCC configuration including an OCC factor and an OCC codeword. The network entity 105 may also evaluate behaviors of the UE 115 to determine whether erroneous cases are occurring, and whether to mitigate the erroneous cases (e.g., via network scheduling). The network entity 105 may also configure or be aware of different dropping and/or multiplexing rules that the UE 115 is configured to support.

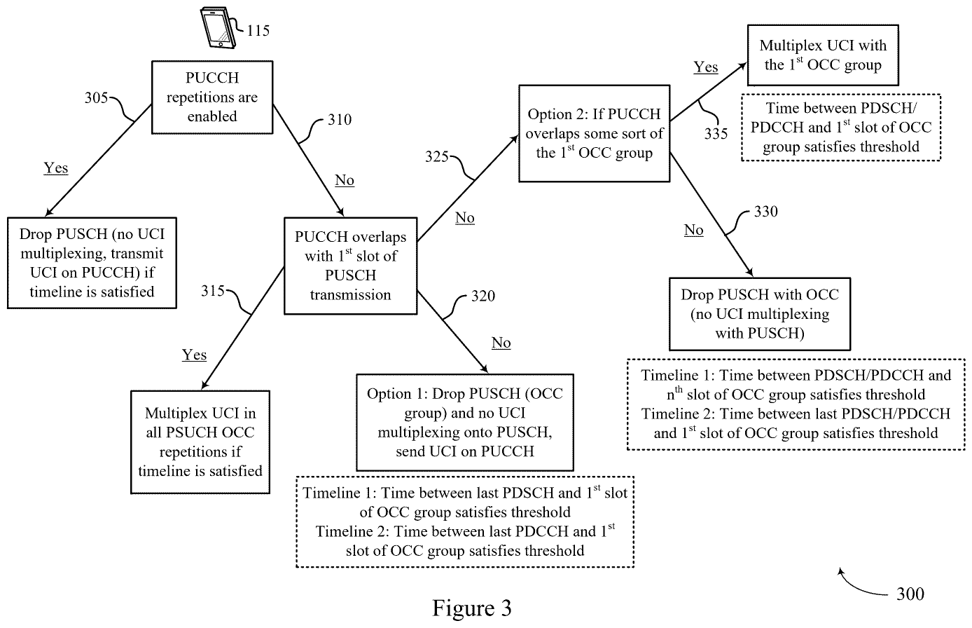

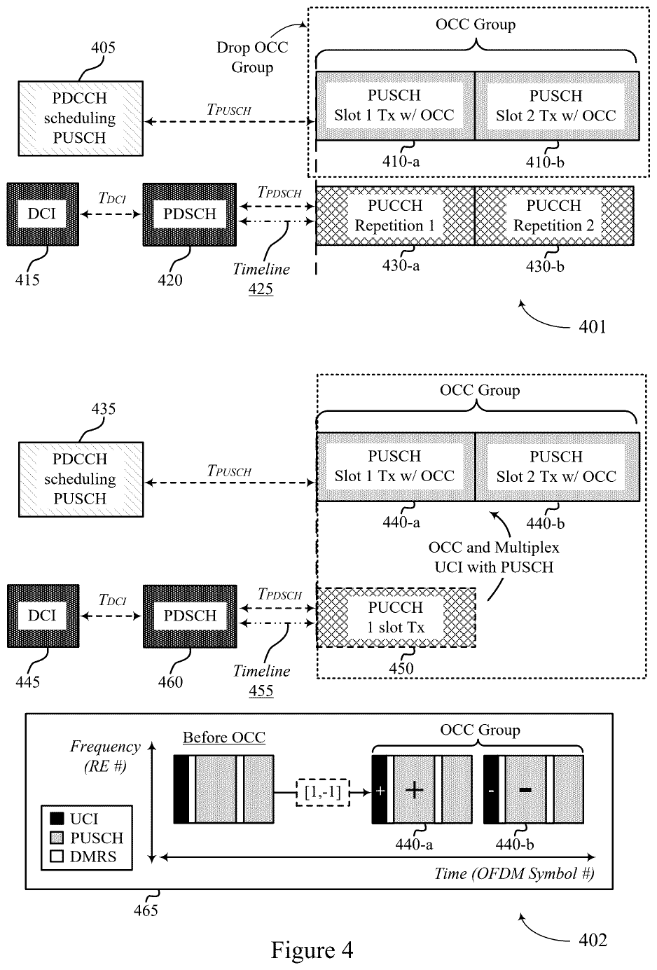

FIG. 3 shows an example of a flow diagram 300 that supports techniques for handling overlapping uplink transmissions using OCC in accordance with various aspects of the present disclosure. For example, the flow diagram 300 may be implemented at or by a UE 115 (such as a UE 115 described herein), and may illustrate a decision process and application of one or more rules (further described with reference to FIGS. 4 through 6) by the UE 115 to handle conflicts between PUCCH transmissions and PUSCH transmissions with OCC.

The flow diagram 300 illustrates a high-level overview of one or more rules that the UE 115 may implement based on various configurations of an overlap occurring between a PUCCH transmission and a PUSCH transmission that is configured using OCC. At a first step, the UE 115 may determine whether PUCCH repetitions are enabled. If PUCCH repetitions are enabled, the UE 115 may follow 305, where the UE 115 may drop the OCC group that includes the PUSCH transmission (e.g., without UCI multiplexing) and may transmit UCI of the PUCCH via the scheduled PUCCH transmission. The UE 115 may follow 305 if a first timeline is met (e.g., if the difference between a PUCCH trigger event and the start of the PUSCH transmission satisfies a threshold duration).

If the UE 115 determines that PUCCH repetitions are not enabled, the UE 115 may follow 310 to determine whether the PUCCH overlaps with a first slot of the OCC group that includes the PUSCH transmission. If the PUCCH overlaps with the first slot of the OCC group that includes the PUSCH transmission, the UE 115 may follow 315 and may multiplex the UCI in each repetition of the PUSCH OCC group and may drop the PUCCH based on the multiplexing of the UCI. The UE 115 may follow 315 if a first timeline is met (e.g., if the difference between a PUCCH trigger event and the start of the PUSCH transmission satisfies a threshold duration). If the PUCCH does not overlap with the first slot of the OCC group that includes the PUSCH transmission, the UE 115 may follow either 320 or 325. For example, if the UE 115 follows 320, the UE 115 may drop the OCC group that includes the PUSCH and may not multiplex the UCI of the PUCCH with the PUSCH. Instead, the UE 115 may transmit the UCI via the PUCCH transmission. In some examples, the UE 115 may follow 320 if one or more timelines are satisfied. For example, a first timeline may be satisfied if the time between the last PDSCH and the first slot of OCC group satisfies threshold duration, and a second timeline may be satisfied if the time between time between last PDCCH (e.g., DCI) and 1^{st} slot of the OCC group satisfies threshold duration.

The timeline conditions for resolving overlapping transmissions between PUSCH with OCC and PUCCH may be applicable to or determined relative to the first repetition of the PUSCH transmission in an OCC group. In some examples, the transmission time includes processing time that occurs between reception of a PUCCH triggering message (such as a PDSCH or DCI) and the PUCCH transmission, processing time between reception of control information and transmission of the PUSCH transmission, or both. The UE 115 may determine whether to drop an OCC group or multiplex UCI based on whether the transmission time exceeds threshold durations. For example, a first timeline may be satisfied if the time between a PUCCH trigger event and the start of the first PUSCH repetition in an OCC group satisfies a threshold duration. A second timeline may be satisfied if the time between a last PDCCH (e.g., DCI) and the first slot of the OCC group satisfies a threshold duration. In some aspects, the timeline conditions allow for the UE 115 to have sufficient processing time to implement the dropping or multiplexing behavior.

If the UE 115 follows 325, the UE 115 may determine whether the PUCCH overlaps with a slot of the first OCC group of the PUSCH. If the UE 115 determines that the PUCCH does overlap with a slot of the first OCC group, the UE 115 may follow 335 and may multiplex the UCI of the PUCCH with the PUSCH of the first OCC group so long as the time between the last PDSCH and/or PDCCH (which schedule the PUCCH) and the first slot of the first OCC group satisfies a threshold time duration. If the UE 115 determines that the PUCCH does not overlap with a slot of the first OCC group (e.g., if the PUCCH overlaps with a slot of an n^{th} OCC group of the PUSCH), the UE may follow 330 and may drop the PUSCH with OCC if one or more timelines are satisfied. For example, a first timeline may be a time between the last PDSCH and/or PDCCH and the n^{th} slot of the n^{th} OCC group satisfies a threshold duration, and a second timeline may be a time between the last PDSCH and/or PDCCH and the first slot of the first OCC group satisfies a threshold duration. In such cases, the UE 115 may not multiplex the UCI of the PUCCH onto the PUSCH and may instead transmit the UCI via the PUCCH.

FIG. 4 shows an example of a dropping rule 401 and multiplexing rule 402 that each support techniques for handling overlapping uplink transmissions using OCC in accordance with various aspects of the present disclosure. For example, the dropping rule 401 and the multiplexing rule 402 may each be implemented at or by a UE 115 as described herein to handle cases of PUCCH and PUSCH (with OCC) overlap, where the PUCCH and the PUSCH may have the same transmission priorities. In each of the dropping rule 401 and the multiplexing rule 402, the UE 115 is configured to support M=2 (e.g., an OCC group includes two slots) for multiplexing two UEs for illustrative purposes, although different values of M are also supported. Although the configuration for a single UE 115 is shown, the dropping rule 401 and multiplexing rule 402 are applicable to each of the UEs associated with the OCC configuration.

The dropping rule 401 illustrates an example communications configuration in which the UE 115 receives a PDCCH transmission 405 that includes a scheduling for a PUSCH transmission of an OCC group. In some examples, the PUSCH transmission may be spread over two slots (e.g., PUSCH slot 410-a and PUSCH slot 410-b) in accordance with the OCC configuration to form the OCC group. The UE 115 may support a duration T_{PUSCH} which is a time period between when the UE 115 receives the PDCCH transmission 405 and when the UE transmits the PUSCH transmission and is a time in which the UE 115 processes the PDCCH transmission 405 and prepares the PUSCH transmission.

The UE 115 may receive a PUCCH triggering event (e.g., which may include reception of the DCI 415, reception of the PDSCH 420, or both, each of which are subject to processing timelines T_{DCI} and T_{PDSCH}) which schedules a corresponding PUCCH or requests feedback in the form of UCI or HARQ. In some cases, the PUCCH triggering event may schedule a PUCCH transmission that has two repetitions (e.g., PUCCH repetition 430-a and PUCCH repetition 430-b), which may overlap with the PUSCH slot 410-a and PUSCH slot 410-b that form the OCC group.

In such cases where the PUCCH is scheduled with repetitions that overlap the PUSCH, the UE 115 may drop the OCC group that includes the PUSCH transmissions. In such cases the UE 115 may not multiplex the UCI from the PUCCH onto the PUSCH, but may instead drop the PUSCH and transmit the PUCCH via the PUCCH repetition 430-a and PUCCH repetition 430-b. In some cases, the UE 115 may support the dropping of the PUSCH so long that the timeline 425 is satisfied. That is, if the time difference between the PUCCH trigger (e.g., the DCI 415 and/or the PDSCH 420) and the start of the PUSCH slot 410-a is greater than or equal to a threshold duration (e.g., if the UE 115 has a sufficient amount of time to process the PUCCH trigger event and drop the PUSCH), the UE 115 may support the dropping rule 401.

The multiplexing rule 402 illustrates an example communications configuration in which the UE 115 receives a PDCCH transmission 435 that includes a scheduling for a PUSCH transmission of an OCC group. In some examples, the PUSCH transmission may be spread over two slots (e.g., PUSCH slot 440-a and PUSCH slot 440-b) in accordance with the OCC configuration to form the OCC group. The UE 115 may support a duration T_{PUSCH} which is a time period between when the UE 115 receives the PDCCH transmission 405 and when the UE transmits the PUSCH transmission and is a time in which the UE 115 processes the PDCCH transmission 405 and prepares the PUSCH transmission.

The UE 115 may receive a PUCCH triggering event (e.g., which may include reception of the DCI 445, reception of the PDSCH 460, or both, each of which are subject to processing timelines T_{DCI} and T_{PDSCH}) which schedules a PUCCH transmission 450 or requests feedback in the form of UCI or HARQ. In some cases, the PUCCH triggering event may schedule a single PUCCH transmission (e.g., a PUCCH transmission without repetitions), and the PUCCH transmission 450 may overlap with the PUSCH slot 440-a (e.g., the PUCCH transmission 450 may overlap with a first PUSCH slot of the PUSCH transmission of the OCC group).

In such cases where the PUCCH transmission 450 is scheduled without repetitions and overlaps the first slot of the PUSCH of the OCC group, the UE 115 may OCC the UCI of the PUCCH transmission 450, and may multiplex the UCI with the PUSCH transmission. In such cases the UE 115 multiplex the UCI from the PUCCH transmission 450 onto the PUSCH (e.g., the UE 115 may puncture the PUSCH to make room for the UCI) and may correspondingly drop the PUCCH transmission 450 (because the UCI from the PUCCH transmission 450 is multiplexed with the PUSCH) and may transmit the OCC group that includes the PUSCH transmission and UCI. In some cases, the UE 115 may support multiplexing the UCI of the PUCCH with the PUSCH so long that the timeline 455 is satisfied. That is, if the time difference between the PUCCH trigger (e.g., the DCI 445 and/or the PDSCH 460) and the start of the PUSCH slot 440-a is greater than or equal to a threshold duration (e.g., if the UE 115 has a sufficient amount of time to process the PUCCH trigger event OCC the UCI and multiplex the UCI with the PUSCH), the UE 115 may support the multiplexing rule 402.

In some examples, the UE 115 may OCC the UCI with the PUSCH of the OCC group using the same OCC scheme (e.g., OCC scheme 465) that is used to OCC the PUSCH. For example, prior to OCC, the PUSCH transmission may occupy a single slot with DMRS and a location for multiplexing UCI. For M=2 transmissions from two UEs, the UE 115 may input a first encoded slot to an OCC matrix. For example, for the OCC matrix, the UE 115 may use a row of the OCC matrix that may correspond to a vector of [1, −1]. When given slot 1 as an input, outputs a product including two respective spread slots (e.g., PUSCH slot 440-a and PUSCH slot 440-b), where the PUSCH slot 440-a is a slot with a same PUSCH and UCI value as the input slot, and PUSCH slot 440-b is a negative output of the PUSCH and UCI value of the input slot. Additionally, or alternatively, the UE may be multiplexed with a row of the OCC matrix that corresponds to a vector [1,1]. When given the input slot, a product may be output that includes two respective spread slots, where both the PUSCH slot 440-a and the PUSCH slot 440-b have a same PUSCH and UCI value as the input slot. In such cases, if the PUCCH collides with the first slot (e.g., PUSCH slot 440-a) in the OCC group, the UE 115 may apply OCC to the PUCCH and/or UCI as well, so the symbols corresponding to PUCCH and/or the UCI will also be scaled and spread according to the OCC codeword ([1, −1] or [1,1], as described herein). Because the UE 115 spreads the data and UCI using OCC, as long as the other UE use the other OCC codeword to spread data (e.g., if the UE 115 uses [1, −1] the other UE may use [1,1], and vice versa), the transmissions for both UEs will be orthogonal, allowing the network entity to correctly decode transmissions from both UEs.

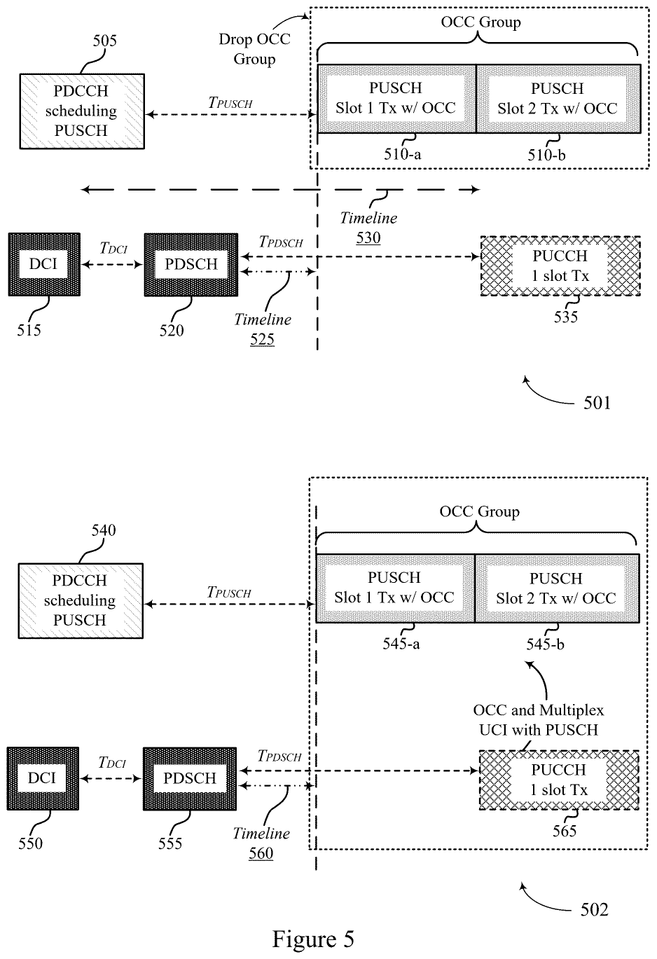

FIG. 5 shows an example of a dropping rule 501 and a multiplexing rule 502 that support techniques for handling overlapping uplink transmissions using OCC in accordance with various aspects of the present disclosure. For example, the dropping rule 501 and the multiplexing rule 502 may each be implemented at or by a UE 115 as described herein to handle cases of PUCCH and PUSCH (with OCC) overlap, where the PUCCH and the PUSCH may have the same transmission priorities. In each of the dropping rule 501 and the multiplexing rule 502, the UE 115 is configured to support M=2 (e.g., an OCC group includes two slots) for multiplexing two UEs for illustrative purposes, although different values of M are also supported. Although the configuration for a single UE 115 is shown, the dropping rule 501 and multiplexing rule 502 are applicable to each of the UEs associated with the OCC configuration.

The dropping rule 501 illustrates an example communications configuration in which the UE 115 receives a PDCCH transmission 505 that includes a scheduling for a PUSCH transmission of an OCC group. In some examples, the PUSCH transmission may be spread over two slots (e.g., PUSCH slot 510-a and PUSCH slot 510-b) in accordance with the OCC configuration to form the OCC group. The UE 115 may support a duration T_{PUSCH} which is a time period between when the UE 115 receives the PDCCH transmission 505 and when the UE transmits the PUSCH transmission and is a time in which the UE 115 processes the PDCCH transmission 505 and prepares the PUSCH transmission.

The UE 115 may receive a PUCCH triggering event (e.g., which may include reception of the DCI 515, reception of the PDSCH 520, or both, each of which are subject to processing timelines T_{DCI} and T_{PDSCH}) which schedules a corresponding PUCCH or requests feedback in the form of UCI (e.g., one or more types of UCI), CSI (periodic or aperiodic CSI) or HARQ. In some cases, the PUCCH triggering event may schedule a single-slot PUCCH transmission without repetitions (e.g., PUCCH transmission 535), which may overlap with the second PUSCH slot of the OCC group (e.g., PUSCH slot 510-b). “Second PUSCH slot” as described herein may refer to any slot that is not the first positioned PUSCH slot of the OCC group.

In such cases where the PUCCH is scheduled without repetitions, and the PUCCH overlaps with a second PUSCH slot (e.g., not the first PUSCH slot), the UE 115 may drop the OCC group that includes the PUSCH transmissions. In such cases the UE 115 may not multiplex the UCI from the PUCCH onto the PUSCH but may instead drop the PUSCH and transmit the PUCCH via the PUCCH transmission 535. In some cases, the UE 115 may support the dropping of the PUSCH so long that the timeline 525 is satisfied, the timeline 530 is satisfied, or both the timeline 525 and the timeline 530 are satisfied. For example, to support the timeline 525, the time difference between the PDSCH 520 and the start of the PUSCH slot 510-a (e.g., the start of the PUSCH transmission) is greater than or equal to a threshold duration (e.g., if the UE 115 has a sufficient amount of time to process the PDSCH and drop the PUSCH). To support the timeline 530, the time difference between the DCI 515 (e.g., the PDCCH) and the start of the PUSCH in PUSCH slot 510-a is greater than or equal to a threshold duration (e.g., if the UE 115 has a sufficient amount of time to process the DCI 515 and drop the PUSCH).

The multiplexing rule 502 illustrates an example communications configuration in which the UE 115 receives a PDCCH transmission 540 that includes a scheduling for a PUSCH transmission of an OCC group. In some examples, the PUSCH transmission may be spread over two slots (e.g., PUSCH slot 545-a and PUSCH slot 545-b) in accordance with the OCC configuration to form the OCC group. The UE 115 may support a duration T_{PUSCH} which is a time period between when the UE 115 receives the PDCCH transmission 540 and when the UE transmits the PUSCH transmission and is a time in which the UE 115 processes the PDCCH transmission 540 and prepares the PUSCH transmission.

The UE 115 may receive a PUCCH triggering event (e.g., which may include reception of the DCI 550, reception of the PDSCH 555, or both, each of which are subject to processing timelines T_{DCI} and T_{PDSCH}) which schedules a PUCCH transmission 565 or requests feedback in the form of UCI or HARQ. In some cases, the PUCCH triggering event may schedule a single PUCCH transmission (e.g., a PUCCH transmission without repetitions), and the PUCCH transmission 565 may overlap with the PUSCH slot 545-b (e.g., the PUCCH transmission 565 may overlap with a second PUSCH slot, that is, not the first slot, of the PUSCH transmission of the OCC group).

In such cases where the PUCCH transmission 565 is scheduled without repetitions and overlaps the second slot (not the first slot) of the PUSCH of the OCC group, the UE 115 may OCC the UCI of the PUCCH transmission 565 using the techniques described herein (such as OCC scheme 465) and may multiplex the UCI with the PUSCH transmission. In such cases the UE 115 multiplex the UCI from the PUCCH transmission 565 onto the PUSCH (e.g., the UE 115 may puncture the PUSCH to make room for the UCI) and may correspondingly drop the PUCCH transmission 565 (because the UCI from the PUCCH transmission 565 is multiplexed with the PUSCH) and may transmit the OCC group that includes the PUSCH transmission and UCI. In some cases, the UE 115 may support multiplexing the UCI of the PUCCH with the PUSCH so long that the timeline 560 is satisfied. That is, if the time difference between the PUCCH trigger (e.g., the DCI 550 and/or the PDSCH 555) and the start of the PUSCH slot 545-a is greater than or equal to a threshold duration (e.g., if the UE 115 has a sufficient amount of time to process the PUCCH trigger event OCC the UCI and multiplex the UCI with the PUSCH), the UE 115 may support the multiplexing rule 502.

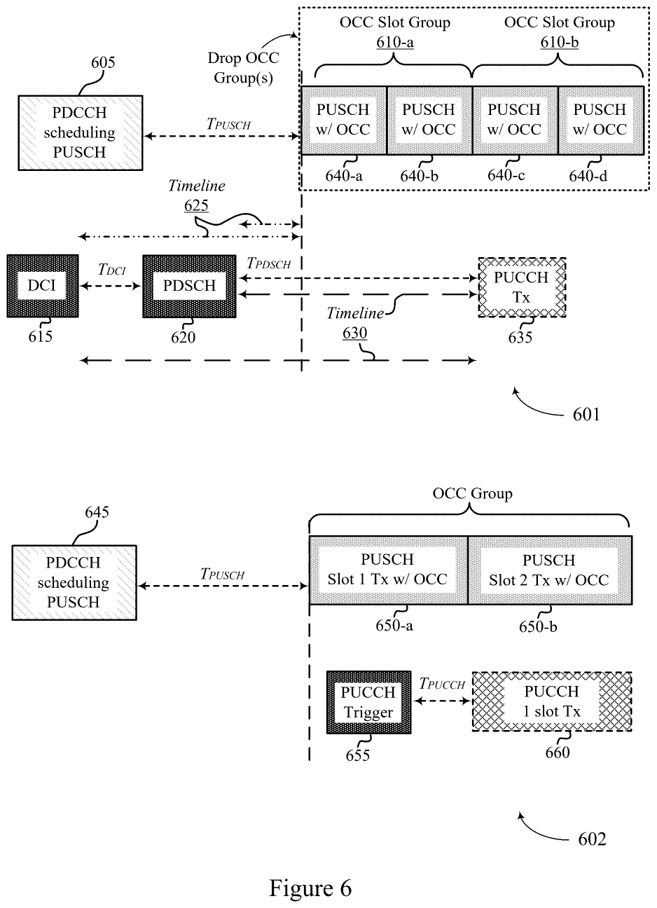

FIG. 6 shows an example of a dropping rule 601 and an error case rule 602 that support techniques for handling overlapping uplink transmissions using OCC in accordance with various aspects of the present disclosure. For example, the dropping rule 601 and the error case rule 602 may each be implemented at or by a UE 115 as described herein to handle cases of PUCCH and PUSCH (with OCC) overlap, where the PUCCH and the PUSCH may have the same transmission priorities. In each of the dropping rule 601 and the error case rule 602, the UE 115 is configured to support M=2 (e.g., an OCC group includes two slots) for multiplexing two UEs for illustrative purposes, although different values of M are also supported. Although the configuration for a single UE 115 is shown, the dropping rule 601 and the error case rule 602 are applicable to each of the UEs associated with the OCC configuration.

The dropping rule 601 illustrates an example communications configuration in which the UE 115 receives a PDCCH transmission 605 that includes a scheduling for a PUSCH transmission of at least two OCC groups. In some examples, the PUSCH transmission may be spread over two slots (e.g., PUSCH slot 640-a and PUSCH slot 640-b) of the first OCC slot group 610-a and two slots (e.g., PUSCH slot 640-c and PUSCH slot 640-d) of the second OCC slot group 610-b. In some aspects, the second OCC slot group 610-b may be an n^{th} OCC group (e.g., not the first OCC slot group 610-a). The UE 115 may support a duration T_{PUSCH} which is a time period between when the UE 115 receives the PDCCH transmission 605 and when the UE transmits the PUSCH transmission.

The UE 115 may receive a PUCCH triggering event (e.g., which may include reception of the DCI 615, reception of the PDSCH 620, or both, each of which are subject to processing timelines T_{DCI} and T_{PDSCH}) which schedules a corresponding PUCCH or requests feedback in the form of UCI or HARQ. In some cases, the PUCCH triggering event may schedule a single-slot PUCCH transmission without repetitions (e.g., PUCCH transmission 635), which may overlap with the first PUSCH slot (e.g., the PUSCH slot 640-c) of the second OCC slot group 610-b.

In such cases where the PUCCH transmission 635 is scheduled without repetitions, and the PUCCH transmission 635 overlaps with a first PUSCH slot (e.g., PUSCH slot 640-c) of the second OCC slot group 610-b, the UE 115 may drop the second OCC slot group 610-b that includes the PUSCH transmissions on PUSCH slot 640-c and PUSCH slot 640-d. In such cases the UE 115 may not multiplex the UCI from the PUCCH onto the PUSCH but may instead drop the PUSCH and transmit the PUCCH via the PUCCH transmission 635. In some cases, the UE 115 may support the dropping of the second OCC slot group 610-b so long that the timelines 625 are satisfied, the timelines 630 are satisfied, or both the timelines 625 and the timelines 630 are satisfied. For example, to support the timelines 625, the time difference between the PDSCH 620 and/or the DCI 615 (e.g., the PDCCH) and the start of the PUSCH slot 640-a (e.g., the first slot of the first OCC slot group 610-a of the PUSCH transmission) is greater than or equal to a threshold duration. To support the timelines 630, the time difference between the PDSCH 620 and/or the DCI 615 (e.g., the PDCCH) and the start of the first slot of an n^{th} OCC group (e.g., the PUSCH slot 640-c of the second OCC slot group 610-b) is greater than or equal to a threshold duration.

In some other examples where the PUCCH transmission 635 is scheduled without repetitions, and the PUCCH transmission 635 overlaps with a first PUSCH slot (e.g., PUSCH slot 640-c) of the second OCC slot group 610-b, the UE 115 may drop both the first OCC slot group 610-a and the second OCC slot group 610-b that include the PUSCH transmissions on PUSCH slot 640-a, PUSCH slot 640-b, PUSCH slot 640-c and PUSCH slot 640-d. In such cases the UE 115 may not multiplex the UCI from the PUCCH onto the PUSCH but may instead drop the PUSCH and transmit the PUCCH via the PUCCH transmission 635. Additionally, or alternatively, the second OCC slot group 610-b may the n^{th} OCC slot group, where one or more additional OCC slot groups are positioned between the first OCC slot group 610-a and the second OCC slot group 610-b. In some cases, the UE 115 may drop all of the OCC slot groups, or just the n^{th} OCC slot group.

The error case rule 602 illustrates an example communications configuration in which the UE 115 receives a PDCCH transmission 645 that includes a scheduling for a PUSCH transmission of an OCC group. In some examples, the PUSCH transmission may be spread over two slots (e.g., PUSCH slot 650-a and PUSCH slot 650-b) in accordance with the OCC configuration to form the OCC group. The UE 115 may support a duration T_{PUSCH} which is a time period between when the UE 115 receives the PDCCH transmission 645 and when the UE transmits the PUSCH transmission.

The UE 115 may receive a PUCCH triggering event 655 (e.g., which may include reception of the DCI, reception of the PDSCH, or both, which are subject to processing timeline T_{PUCCH}) which schedules a PUCCH transmission 660 or requests feedback in the form of UCI or HARQ. In some cases, the UE 115 may receive the PUCCH triggering event 655 during an ongoing transmission of PUSCH in the PUSCH slot 650-a (e.g., the PUCCH triggering event 655 may overlap with the PUSCH transmission), and may schedule a single PUCCH transmission (e.g., a PUCCH transmission without repetitions) that overlaps with the PUSCH slot 650-b (e.g., the PUCCH transmission 660 may overlap with a second PUSCH slot, that is, not the first slot, of the PUSCH transmission of the OCC group).

The UE 115 may support one or more actions responsive to the PUCCH and PUSCH overlap. In some examples, the UE 115 may drop the OCC group based on reception of the PUCCH triggering event 655, or the UE 115 may drop the PUCCH. Additionally, or alternatively, the UE 115 may drop both the OCC group that includes the PUSCH and the PUCCH transmission 660. In some cases, the UE 115 may coordinate with a network entity, and the network entity may modify a scheduling of the PUCCH, the PUSCH, or both, to avoid the scheduling conflict.

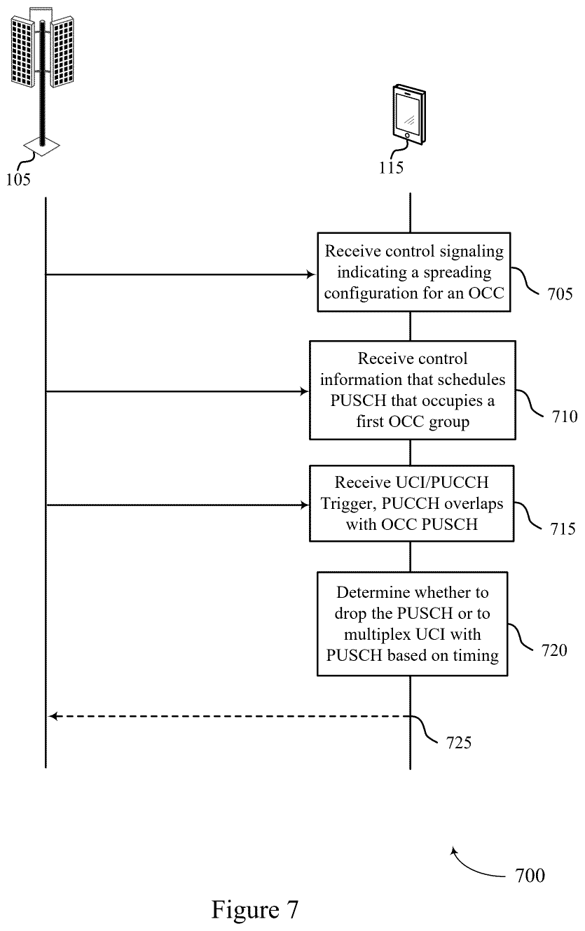

FIG. 7 shows an example of a process flow 700 that supports techniques for handling overlapping uplink transmissions using OCC in accordance with various aspects of the present disclosure. For example, the process flow 700 may support communications between a UE 115 and a network entity 105, each of which may be examples of corresponding devices described herein. In some aspects, the UE 115 may support OCC techniques described herein.

Alternative examples of the following may be implemented. Some steps are performed in a different order than described or are not performed at all. In some implementations, steps may include additional features not mentioned below, or additional steps may be added. Further, although the UE 115 and the network entity 105 are shown performing the operations of the process flow 700, some aspects of some operations may also be performed by one or more other wireless communication devices (such as by multiple network entities, multiple UEs).

At 705, the network entity 105 may transmit (e.g., output) and the UE 115 may receive, control signaling that indicates a spreading configuration corresponding to an OCC for communications of one or more uplink channels. In some examples, the spreading configuration may include or indicate a multiplexing order associated with the OCC, an OCC codeword associated with the OCC, or any combination thereof. In some examples, the UE 115 may transmit UE capability signaling that indicate an OCC capability of the UE 115, a phase coherence capability of the UE 115, a capability of the UE 115 to support transmission of PUSCH and PUCCH in accordance with the transmission time, or any combination thereof.

At 710, the network entity may output, and the UE 115 may receive, control information (such as a PDCCH described with reference to FIGS. 4 through 6) that schedules PUSCH transmission that occupies a first set of slots of a first OCC group that is coded in accordance with the OCC.

At 715, the network entity may output, and the UE 115 may receive, a message (e.g., a DCI message, a PDSCH message, or both, described with reference to FIGS. 4 through 6) that triggers UCI for a PUCCH transmission that occupies a second set of slots. In some aspects, the PUCCH transmission at least partially overlaps with the OCC group of the first set of slots of the PUSCH transmission.

At 720, the UE 115 may determine (when the PUSCH transmission is in accordance with the OCC) whether to drop the first OCC group including the PUSCH transmission or to multiplex the UCI with the PUSCH transmission based on one or more rules associated with a transmission time of the PUCCH transmission relative to the PUSCH transmission. In some examples, the transmission time may include a processing time that occurs between reception of the message and the PUCCH transmission, a processing time between reception of the control message and transmission of the PUSCH transmission, or both. In some examples, the UE 115 may determine whether to drop the PUSCH transmission (and transmit the PUCCH at 725) or whether to multiplex the UCI with the PUSCH transmission (and transmit the UCI multiplexed with the PUSCH at 725) based on whether the transmission time exceeds a threshold duration.

In some examples, the message (e.g., a DCI 415, a PDSCH 420, or both) triggers (e.g., triggers the UE 115 to generate) at least two repetitions of the PUCCH transmission (e.g., PUCCH repetition 430-a and PUCCH repetition 430-b), and the UE 115 may determine to drop the first OCC group that includes the PUSCH transmission based on the one or more rules. For example, the one or more rules may indicate that the first OCC group that includes the PUSCH transmission is to be dropped when the PUCCH transmission is configured with the at least two repetitions and when transmission time between the message and a first slot of the PUSCH satisfies a threshold duration (e.g., timeline 425). The UE 115 may then transmit the UCI via the at least two repetitions of the PUCCH transmission based on the one or more rules.

In some examples, the message (e.g., the DCI 445, the PDSCH 460) triggers generation of the PUCCH transmission without repetition (e.g., PUCCH transmission 450), and the UE 115 may determine to multiplex the UCI of the PUCCH transmission with the PUSCH transmission in accordance with the OCC based on the one or more rules. For example, the one or more rules may indicate that the UCI is to be multiplexed with the PUSCH transmission when the PUCCH transmission is configured without repetition and when the transmission time results in the PUCCH transmission being within a threshold duration of the first slot of the first OCC group. In some examples, the UE 115 may apply the OCC to the UCI and the PUSCH transmission using an OCC codeword that spreads respective data of the UCI and the PUSCH transmission over the first set of slots of the first OCC group.

In some examples, the message (e.g., DCI 515, PDSCH 520) triggers generation of the PUCCH transmission without repetition (e.g., PUCCH transmission 535), and the PUCCH transmission overlaps with a second slot of the first OCC group (e.g., PUSCH slot 510-b). In such cases, the UE 115 may drop the first OCC group that includes the PUSCH transmission based on the one or more rules. For example, the one or more rules may indicate that the first OCC group that includes the PUSCH transmission is to be dropped when the PUCCH transmission is configured without repetitions and when the transmission time results in the PUCCH transmission being within a threshold duration of the PUSCH transmission. In some cases, the transmission time may indicate that the time difference between the message and the first slot of the PUSCH (timeline 525, timeline 530) of the first OCC group satisfies a threshold duration.

In some examples, the message (e.g., DCI 550, PDSCH 555) triggers generation of the PUCCH transmission without repetition (e.g., PUCCH transmission 565), and the PUCCH transmission overlaps with a second slot that is different from a first slot of the first OCC group (e.g., PUSCH slot 545-b). In such examples, the UE 115 may multiplex the UCI of the PUCCH transmission with the PUSCH transmission of the first OCC group based on the one or more rules. For example, the one or more rules may indicate that the UCI is to be multiplexed with the PUSCH when the PUCCH transmission is configured without repetition and when the transmission time results in the message being within a threshold duration of the first slot of the first OCC group (e.g., timeline 560). In some such examples, the UE 115 may apply the OCC to the UCI and the PUSCH transmission using an OCC codeword that spreads respective data of the UCI and the PUSCH transmission over the first set of slots of the first OCC group.

In some examples, the message (e.g., DCI 615, PDSCH 620) triggers generation of the PUCCH transmission without repetition (e.g., PUCCH transmission 635), and the PUCCH transmission overlaps with a second OCC slot group or OCC group (e.g., the second OCC slot group 610-b) that occurs after the first OCC slot group (e.g., first OCC slot group 610-a). In such examples, the UE 115 may drop the second OCC group that includes the PUSCH transmission based on the one or more rules. For example, the one or more rules may indicate that the second OCC group is to be dropped when the PUCCH transmission is configured without repetition and when the transmission time results in the PUCCH transmission being within a threshold duration of the message. The UE 115 may then transmit the UCI via the PUCCH transmission in accordance with the one or more rules and based on dropping the second OCC group that includes the PUSCH transmission.

In some examples, the message triggers generation of the PUCCH transmission without repetition, and the PUCCH transmission overlaps with a second OCC group occurring after the first OCC group. In such examples, the UE 115 may drop the second OCC group that includes the PUSCH transmission based on the one or more rules. For example, the one or more rules may indicate that the second OCC group is to be dropped when the PUCCH transmission is configured without repetition and when the transmission time results in the first OCC group including the PUSCH transmission is within a threshold duration of the message.

In some examples, the UE 115 may receive the message that triggers the UCI of the PUCCH transmission during an ongoing transmission of the PUSCH. In some cases, the network entity 105 may modify the scheduling of the PUCCH, the PUSCH, or both, to mitigate conflict. Additionally, or alternatively, the UE 115 may drop one or more OCC groups that include the PUSCH transmission, the UE 115 may drop the PUCCH transmission, the UE 115 may drop both the PUCCH transmission and the one or more OCC groups that include the PUSCH,

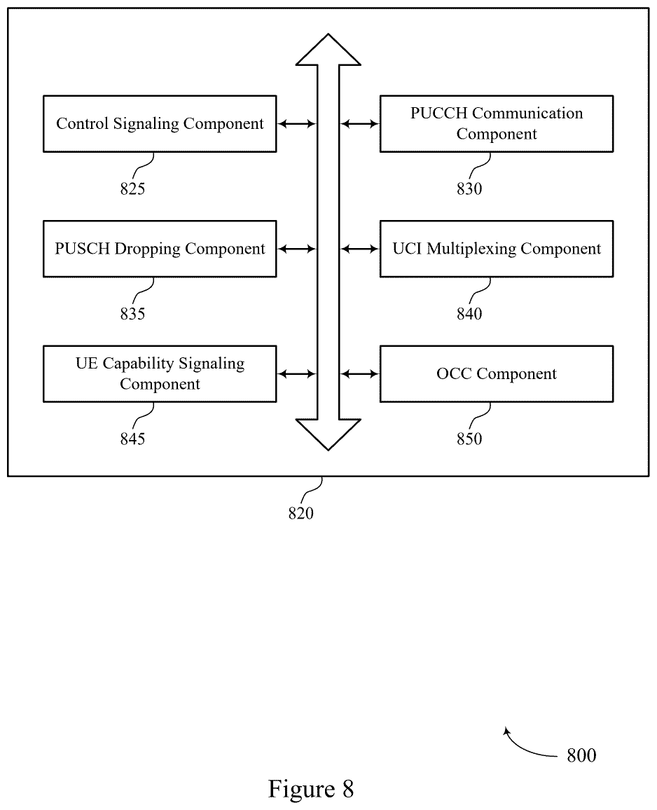

FIG. 8 shows an example of a processing system 820 that supports techniques for handling overlapping uplink transmissions using OCC in accordance with various aspects of the present disclosure. A processing system 820 may be an example of a processing system 140 (such as of a UE 115) and may include a control signaling component 825, a PUCCH communication component 830, an PUSCH dropping component 835, a UCI multiplexing component 840, a UE capability signaling component 845, a OCC component 850, or any combination thereof. A processing system 820, or various component thereof, may be an example of means for performing (such as a means for causing a UE 115 to perform) various techniques described herein.

The control signaling component 825 may be configured to cause the UE 115 to receive control signaling indicating a spreading configuration corresponding to an OCC for communications of one or more uplink channels. In some examples, the control signaling component 825 may be configured to cause the UE 115 to receive control information that schedules an PUSCH transmission that occupies a first set of slots including a first OCC group based on the OCC. In some examples, the control signaling component 825 may be configured to cause the UE 115 to receive a message that triggers UCI for a PUCCH transmission that occupies a second set of slots, where the second set of slots of the PUCCH transmission at least partially overlaps with the first set of slots of the PUSCH transmission. The PUCCH communication component 830 may be configured to cause the UE 115 to determine, when the PUSCH transmission is in accordance with the OCC, whether to drop the first OCC group that includes the PUSCH transmission or to multiplex the UCI with the PUSCH transmission based on one or more rules associated with a transmission time of the PUCCH transmission relative to the PUSCH transmission.

In some examples, the message triggers at least two repetitions of the PUCCH transmission, and the PUSCH dropping component 835 may be configured to cause the UE 115 to drop the first OCC group that includes the PUSCH transmission based on the one or more rules, where the one or more rules indicate that the first OCC group that includes the PUSCH transmission is to be dropped when the PUCCH transmission is configured with the at least two repetitions and when the transmission time results in at least an initial PUCCH repetition being within a threshold duration of the PUSCH transmission. In some examples, the message triggers at least two repetitions of the PUCCH transmission, and the PUCCH communication component 830 may be configured to cause the UE 115 to transmit the UCI via the at least two repetitions of the PUCCH transmission in accordance with the one or more rules and based on dropping the first OCC group that includes the PUSCH transmission.

In some examples, the message triggers the PUCCH transmission without repetition, and the UCI multiplexing component 840 may be configured to cause the UE 115 to multiplex the UCI of the PUCCH transmission with the PUSCH transmission in accordance with the OCC based on the one or more rules, where the one or more rules indicate that the UCI is to be multiplexed with the PUSCH transmission when the PUCCH transmission is configured without repetition and when the transmission time results in the PUCCH transmission being within a threshold duration of the first slot of the first OCC group. In some examples, the OCC component 850 may be configured to cause the UE 115 to apply the OCC to the UCI and the PUSCH transmission using an OCC codeword that spreads respective data of the UCI and the PUSCH transmission over the first set of slots of the first OCC group.

In some examples, the message triggers the PUCCH transmission without repetition, and the PUSCH dropping component 835 may be configured to cause the UE 115 to drop the first OCC group that includes the PUSCH transmission based on the one or more rules, where the one or more rules indicate that the first OCC group that includes the PUSCH transmission is to be dropped when the PUCCH transmission is configured without repetitions and when the transmission time results in the PUCCH transmission being within a threshold duration of the PUSCH transmission. In some examples, the message triggers the PUCCH transmission without repetition, and the PUCCH communication component 830 may be configured to cause the UE 115 to transmit the UCI via the PUCCH transmission in accordance with the one or more rules and based on dropping the first OCC group that includes the PUSCH transmission.

In some examples, the message triggers the PUCCH transmission without repetition, and the UCI multiplexing component 840 may be configured to cause the UE 115 to multiplex the UCI of the PUCCH transmission with the PUSCH transmission of the first OCC group based on the one or more rules, where the one or more rules indicate that the UCI is to be multiplexed with the PUSCH when the PUCCH transmission is configured without repetition and when the transmission time results in the PUCCH transmission being within a threshold duration of the second slot of the first OCC group. In some examples, the OCC component 850 may be configured to cause the UE 115 to apply the OCC to the UCI and the PUSCH transmission using an OCC codeword that spreads respective data of the UCI and the PUSCH transmission over the first set of slots of the first OCC group.

In some examples, the message triggers the PUCCH transmission without repetition, and the PUSCH dropping component 835 may be configured to cause the UE 115 to drop the at least one additional OCC group, the first OCC group, or both, that include the PUSCH transmission based on the one or more rules, where the one or more rules indicate that the at least one additional OCC group, the first OCC group, or both, are to be dropped when the PUCCH transmission is configured without repetition and when the transmission time results in the PUCCH transmission being within a threshold duration of the message. In some examples, the message triggers the PUCCH transmission without repetition, and the PUCCH communication component 830 may be configured to cause the UE 115 to transmit the UCI via the PUCCH transmission in accordance with the one or more rules and based on dropping the at least one additional OCC group, the first OCC group, or both, that include the PUSCH transmission.

In some examples, the message triggers the PUCCH transmission without repetition, and the PUSCH dropping component 835 may be configured to cause the UE 115 to drop the at least one additional OCC group, the first OCC group, or both, that include the PUSCH transmission based on the one or more rules, where the one or more rules indicate that the at least one additional OCC group, the first OCC group, or both, are to be dropped when the PUCCH transmission is configured without repetition and when the transmission time results in the first OCC group including the PUSCH transmission is within a threshold duration of the message. In some examples, the message triggers the PUCCH transmission without repetition, and the PUCCH communication component 830 may be configured to cause the UE 115 to transmit the UCI via the PUCCH transmission in accordance with the one or more rules and based on dropping the at least one additional OCC group, the first OCC group, or both, that include the PUSCH transmission.

In some examples, during transmission of the PUSCH transmission, the UE 115 receives the message that triggers the UCI of the PUCCH transmission, and the PUSCH dropping component 835 may be configured to cause the UE 115 to drop one or more OCC groups that include the PUSCH transmission based on reception of the message. In some examples, during transmission of the PUSCH transmission, the UE 115 receives the message that triggers the UCI of the PUCCH transmission, and the PUCCH communication component 830 may be configured to cause the UE 115 to drop the PUCCH transmission based on reception of the message during transmission of the PUSCH transmission. In some examples, during transmission of the PUSCH transmission, the UE 115 receives the message that triggers the UCI of the PUCCH transmission, and the PUSCH dropping component 835 may be configured to cause the UE 115 to drop both the PUCCH transmission and the one or more OCC groups that include the PUSCH transmission.

In some examples, the UE capability signaling component 845 may be configured to cause the UE 115 to transmit one or more UE capability messages indicative of an OCC capability of the UE, a phase coherence capability of the UE, a capability of the UE to support transmission of PUSCH and PUCCH in accordance with the transmission time, or any combination thereof. In some examples, the OCC component 850 may be configured to cause the UE 115 to receive control signaling that indicates a multiplexing order associated with the OCC, an OCC codeword associated with the OCC, or any combination thereof. In some examples, the message includes an PDSCH transmission, a DCI message, or both. In some examples, the transmission time is based on a time duration between the PUCCH transmission and the message. In some examples, the PUSCH transmission and the PUCCH transmission have a same transmission priority.

In some examples, the transmission time includes a processing time that occurs between reception of the message and the PUCCH transmission, a processing time between reception of the control message and transmission of the PUSCH transmission, or both. In some examples, determining whether to drop the first OCC group that includes the PUSCH transmission or to multiplex the UCI with the PUSCH transmission is further based on whether the transmission time exceeds a threshold duration.

A processing system 820 may include or be a component of one or more chips, systems-on-chips (SoCs), chipsets, packages, components, or devices that individually or collectively constitute or include a processing system. A processing system 820 may interface with other components of a processing system 820. For example, operations described with reference to a processing system 820, or various components thereof, may be performed by or with other such components, including a receiver, a transmitter, a transceiver, a modem, a user interface, a modulator/demodulator, an encoder/decoder, or any combination thereof (such as of the processing system 820, coupled with the processing system 820, of a processing system 820).

By including or configuring a processing system 820 for operation in a processing system 820 as described herein, the processing system 820 may support techniques for more efficient utilization of communication resources using OCC techniques, improved communications quality related to reduced network congestion, higher throughput, and improved coordination between devices.

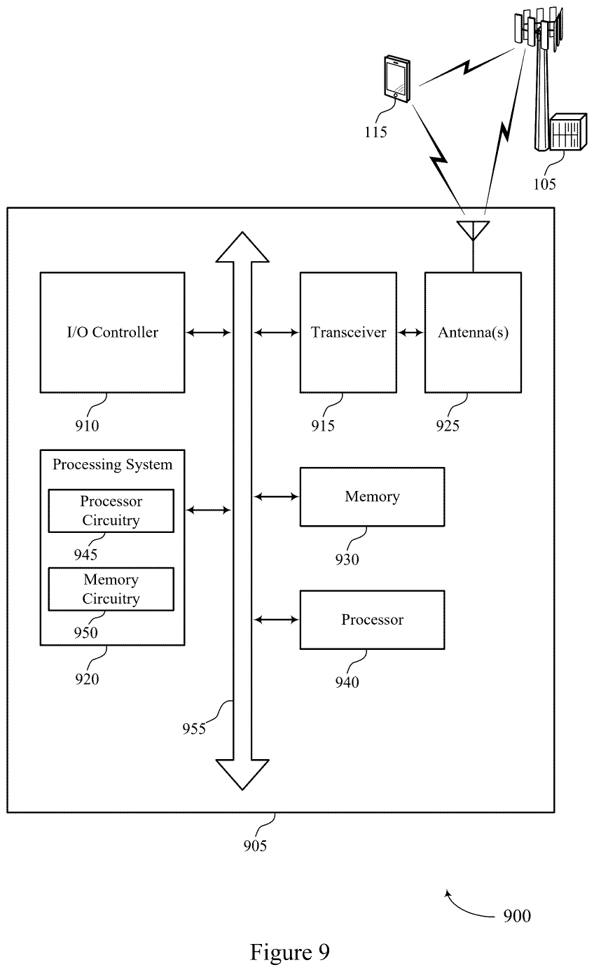

FIG. 9 shows an example of a system 900 including a device 905 that supports techniques for handling overlapping uplink transmissions using OCC in accordance with various aspects of the present disclosure. The device 905 may be an example of or include components of UE 115. The device 905 may communicate (such as wirelessly) with one or more other devices (such as network entities 105, UEs 115). The device 905 may include components for transmitting and receiving communication, which may include a processing system 920, an input/output (I/O) controller, such as an I/O controller 910, a transceiver 915, antenna(s) 925, a memory 930, and a processor 940. Components of the device 905 may be coupled (such as operatively, communicatively, functionally, electronically, electrically, in electronic communication) a bus 955.

The transceiver 915 may support bi-directional communication via antenna(s) 925, and may support transmission operations, reception operations, or both, as described herein. The transceiver 915 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 905). The transceiver 915 may modulate symbols and provide the modulated symbols to antenna(s) 925 for transmission, and demodulate symbols from signals received using antenna(s) 925.

The processor 940 may be a general-purpose processing component that supports various operations (such as applications) of the device 905. The memory 930 may be a general-purpose storage component that stores code executable by the processor 940. Such code may include instructions that, when executed by the processor 940, cause the device 905 to perform various functions (such as to support an application of the device 905). The I/O controller 910 may manage inputs and outputs for the device 905, may manage peripherals not integrated into the device 905, or may represent a physical connection (such as port) to an external peripheral. The processor 940 may interact with a modem, a keyboard, a mouse, a touchscreen, or other device (such as via I/O controller 910). In some implementations, a user may interact with the device 905 via the I/O controller 910 or via hardware components controlled by the I/O controller 910.

The processing system 920 may be an example of a processing system 140 or a processing system 800. For example, the processing system 920 may include processor circuitry 945 and memory circuitry 950 that stores code, and may be configured to cause the device 905 to perform operations that support techniques for handling overlapping uplink transmissions using OCC. Although the processing system 920 is illustrated as a separate component, which may involve a separate chip, chipset, or other component, in some implementations, one or more functions described with reference to the processing system 920 may be supported by or performed by a transceiver 915, antenna(s) 925, a processor 940, memory 930, or any combination thereof, such that a processing system 920 may include one or more of a transceiver 915, antenna(s) 925, a processor 940, memory 930, or any combination thereof.

By including or configuring the processing system 920 for operation in the device 905 as described herein, may support techniques for improved communication reliability, reduced latency, more efficient utilization of communication resources using OCC techniques, higher throughput, reduced congestion, an improved coordination between devices including for scheduling of PUCCH and PUSCH.

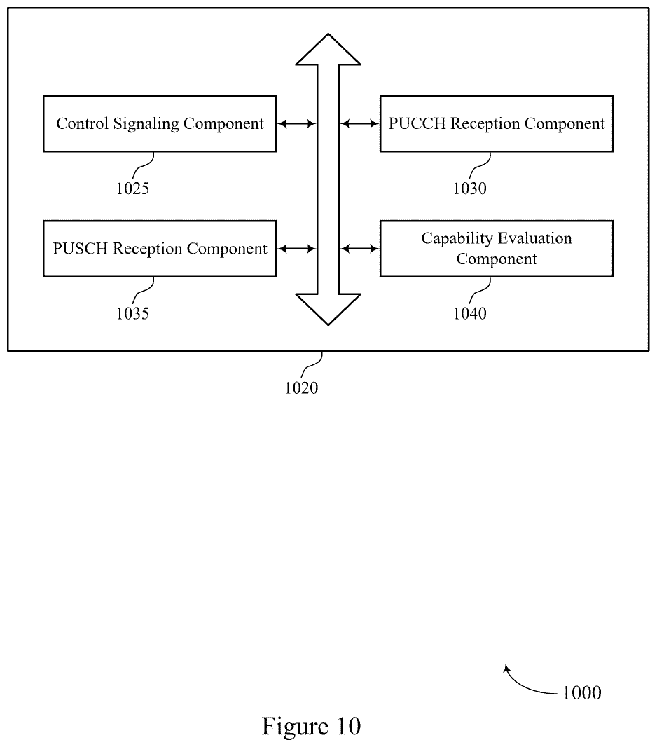

FIG. 10 shows an example of a processing system 1020 that supports techniques for handling overlapping uplink transmissions using OCC in accordance with various aspects of the present disclosure. A processing system 1020 may be an example of a processing system 145 (such as network entity 105) and may include a control signaling component 1025, a PUCCH reception component 1030, an PUSCH reception component 1035, a capability evaluation component 1040, or any combination thereof. A processing system 1020, or various component thereof, may be an example of means for performing (such as a means for causing a network entity 105 to perform) various techniques described herein.

The control signaling component 1025 may be configured to cause the network entity 105 to output control signaling indicating a spreading configuration corresponding to an orthogonal cover coding (OCC) for communications of one or more uplink channels. In some examples, the control signaling component 1025 may be configured to cause the network entity 105 to output control information that schedules an PUSCH transmission that occupies a first set of slots including a first OCC group based on the OCC. In some examples, the control signaling component 1025 may be configured to cause the network entity 105 to output a message that is associated with UCI for a PUCCH transmission that occupies a second set of slots, where the second set of slots of the PUCCH transmission at least partially overlaps with the first set of slots of the PUSCH transmission. The PUCCH reception component 1030 may be configured to cause the network entity 105 to determine, when the PUSCH transmission is in accordance with the OCC, whether to receive the UCI multiplexed with the PUSCH transmission, or whether to expect reception of the PUCCH transmission without reception of the PUSCH transmission based on one or more rules associated with a transmission time of the PUCCH transmission relative to the PUSCH transmission.

In some examples, the message is associated with at least two repetitions of the PUCCH transmission, and the PUCCH reception component 1030 may be configured to cause the network entity 105 to obtain the UCI via the at least two repetitions of the PUCCH transmission in accordance with the one or more rules, where the one or more rules indicate that the first OCC group that includes the PUSCH transmission is to be dropped when the PUCCH transmission is configured with the at least two repetitions and when the transmission time results in at least an initial PUCCH repetition being within a threshold duration of the PUSCH transmission.

In some examples, the message is associated with the PUCCH transmission without repetition, and the PUSCH reception component 1035 may be configured to cause the network entity 105 to obtain the UCI multiplexed with the PUSCH transmission in accordance with the OCC based on the one or more rules, where the one or more rules indicate the UCI is to be multiplexed with the PUSCH transmission when the PUCCH transmission is configured without repetition and when the transmission time results in the PUCCH transmission being within a threshold duration of the first slot of the first set of slots of the PUSCH transmission.

In some examples, the message is associated with the PUCCH transmission without repetition, and the PUCCH reception component 1030 may be configured to cause the network entity 105 to obtain the UCI via the PUCCH transmission in accordance with the one or more rules, where the one or more rules indicate that the first OCC group that includes the PUSCH transmission is to be dropped when the PUCCH transmission is configured without repetitions and when the transmission time results in the PUCCH transmission being within a threshold duration of the PUSCH transmission.

In some examples, the message is associated with the PUCCH transmission without repetition, and the PUSCH reception component 1035 may be configured to cause the network entity 105 to obtain the UCI multiplexed with the PUSCH transmission in accordance with the OCC of the first OCC group based on the one or more rules, where the one or more rules indicate that the UCI is to be multiplexed with the PUSCH when the PUCCH transmission is configured without repetition and when the transmission time results in the PUCCH transmission being within a threshold duration of the second slot of the first OCC group.

In some examples, the message is associated with the PUCCH transmission without repetition, and the PUCCH reception component 1030 may be configured to cause the network entity 105 to obtain the UCI via the PUCCH transmission in accordance with the one or more rules, where the one or more rules indicate that the PUSCH transmission in the at least one additional OCC group, the first OCC group, or both, are to be dropped when the PUCCH transmission is configured without repetition and when the transmission time results in the PUCCH transmission being within a threshold duration of the message.

In some examples, the message is associated with the PUCCH transmission without repetition, and the PUCCH reception component 1030 may be configured to cause the network entity 105 to obtain the UCI via the PUCCH transmission based on the one or more rules, where the one or more rules indicate that the at least one additional OCC group, the first OCC group, or both, are to be dropped when the PUCCH transmission is configured without repetition and when the transmission time results in the first OCC group including the PUSCH transmission is within a threshold duration of the message.

In some examples, the control signaling component 1025 may be configured to cause the network entity 105 to modify a first scheduling of the message associated with the UCI of the PUCCH transmission based on the first scheduling indicating that the message is at least partially overlapping with the PUSCH transmission. In some examples, the capability evaluation component 1040 may be configured to cause the network entity 105 to obtain one or more UE capability messages indicative of an OCC capability of the UE, a phase coherence capability of the UE, a capability of the UE to support transmission of PUSCH and PUCCH in accordance with the transmission time, or any combination thereof.

In some examples, the control signaling component 1025 may be configured to cause the network entity 105 to output control signaling that indicates a multiplexing order associated with the OCC, an OCC codeword associated with the OCC, or any combination thereof. In some examples, the message includes an PDSCH transmission, a DCI message, or both. In some examples, the transmission time is based on a time duration between the PUCCH transmission and the message. In some examples, the PUSCH transmission and the PUCCH transmission have a same transmission priority.

In some examples, the transmission time includes a processing time that occurs between reception of the message and the PUCCH transmission, a processing time between reception of the control message and transmission of the PUSCH transmission, or both. In some examples, determining whether to drop the first OCC group that includes the PUSCH transmission or to multiplex the UCI with the PUSCH transmission is further based on whether the transmission time exceeds a threshold duration.

A processing system 1020 may include or be an example of one or more chips, SoCs, chipsets, packages, components, or devices that individually or collectively constitute or include a processing system. A processing system 1020 may interface with other components of a network entity 105. For example, operations described with reference to a processing system 1020, or various components thereof, may be performed by or with other such components, including a receiver, a transmitter, a transceiver, a modem, a user interface, a modulator/demodulator, an encoder/decoder, or any combination thereof (such as of the processing system 1020, coupled with the processing system 1020, of a network entity 105). Operations described herein with reference to the processing system 1020, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 1020 for operation in a processing system 1020 as described herein, the processing system 1020 may support techniques for more efficient utilization of communication resources using OCC techniques, improved communications quality related to reduced network congestion, higher throughput, and improved coordination between devices.

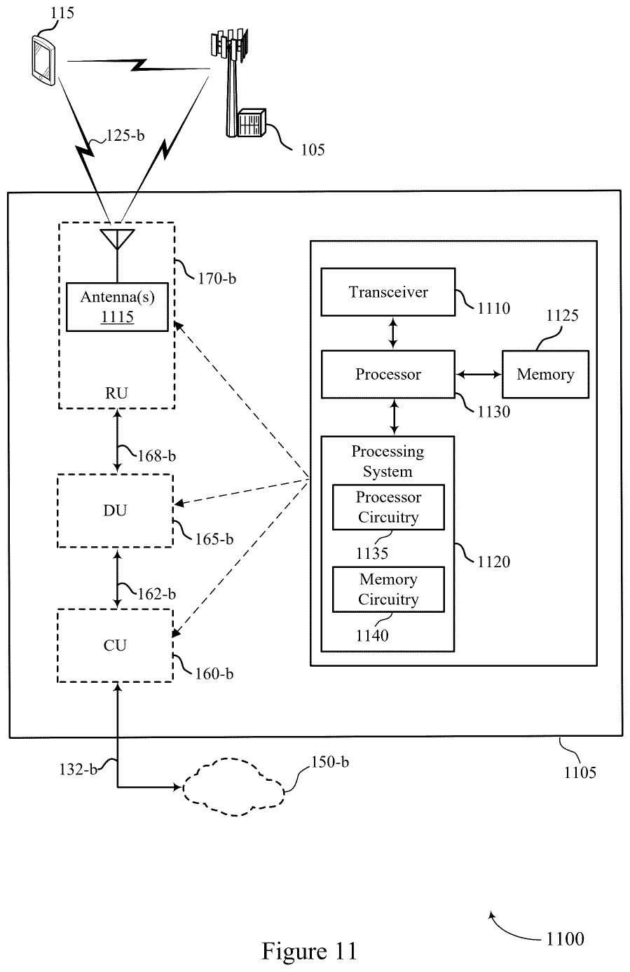

FIG. 11 shows an example of a system 1100 including a device 1105 that supports techniques for handling overlapping uplink transmissions using OCC in accordance with various aspects of the present disclosure. The device 1105 may communicate (such as via one or more wired interfaces or one or more wireless interfaces) with other network devices or network equipment such as a core network 150-b, other network entities 105, UEs 115, or any combination thereof. The device 1105 may include components for transmitting and receiving communication, which may include a processing system 1120, a transceiver 1110, antenna(s) 1115, a memory 1125, and a processor 1130. Components of the device 1105 may be coupled (such as operatively, communicatively, functionally, electronically, electrically, in electronic communication) via one or more interfaces.

The transceiver 1110 may communicate bi-directionally with another transceiver via wired or wireless links, and may support transmission operations, reception operations, or both, as described herein. The transceiver 1110 may include a modem to modulate and demodulate signals, to provide the modulated signals for transmission (such as via antenna(s) 1115, via a wired interface), and to demodulate received signals (such as received via antenna(s) 1115, received via a wired interface). The transceiver 1110 may be operable to support communication via one or more communication links (such as a communication link 125-b, a backhaul link 132-b, a midhaul link 162-b, fronthaul link 168-b).

The processor 1130 may be a general-purpose processing component that supports various operations (such as applications) of the device 1105. The memory 1125 may be a general-purpose storage component that stores code executable by the processor 1130. Such code may include instructions that, when executed by the processor 1130, cause the device 1105 to perform various functions (such as to support an application of the device 1105).

For examples in which the device 1105 is a network entity 105 in a disaggregated architecture, one or more components of the device 1105 may be located at one or more of a CU 160-b, a DU 165-b, or an RU 170-b, one or more of which may include aspects of the processing system 1120, the processor 1130, the memory 1125, or the transceiver 1110. Functions of the device 1105 may be performed at different components or an operation may be divided between different components (such as different functions being supported by aspects of the CU 160-b, the DU 165-b, or the RU 170-b, the transceiver 1110, the processor 1130, the memory 1125, the processing system 1120, or any combination thereof). For example, the processing system 1120 may be a component of one or more of the CU 160-b, the DU 165-b, or the RU 170-b. In some examples, interfaces between components of device 1105 (such as CU 160-b, DU 165-b, RU 170-b) may support communication at a protocol layer or between protocol layers of a protocol stack.

In some examples, the processing system 1120 may manage aspects of communication with the core network 150-b (such as via a backhaul link 132). For example, the processing system 1120 may manage the transfer of data communication for UEs 115 with a gateway of the core network 150-b. In some examples, the processing system 1120 may manage communication with one or more other network entities 105 and may include a controller or scheduler for controlling communication with UEs 115 (such as in cooperation with the one or more other network entities 105). In some examples, the processing system 1120 may support an interface (such as X2 interface, Xn interface) to provide communication between network entities 105.

The processing system 1120 may be an example of a processing system 145 or a processing system 1000. For example, the processing system 1120 may include processor circuitry 1135 and memory circuitry 1140 that stores code, and the processing system 1120 may be configured to cause the device 1105 to perform operations that support techniques for handling overlapping uplink transmissions using OCC. Although the processing system 1120 is illustrated as a separate component, which may involve a separate chip, chipset, or other component, in some implementations, one or more functions described with reference to the processing system 1120 may be supported by or performed by a transceiver 1110, antenna(s) 1115, a processor 1130, memory 1125, or any combination thereof, such that a processing system 1120 may include one or more of a transceiver 1110, antenna(s) 1115, a processor 1130, memory 1125, or any combination thereof. Further, processor circuitry 1135 and memory circuitry 1140 each may be implemented at the device 1105 in accordance with an aggregated architecture, or the processor circuitry 1135 and the memory circuitry 1140 may be implemented at one or more of a CU 160-b, a DU 165-b, or an RU 170-b in accordance with a disaggregated architecture.

By including or configuring the processing system 1120 for operation in the device 1105 as described herein, may support techniques for improved communication reliability, reduced latency, more efficient utilization of communication resources using OCC techniques, higher throughput, reduced congestion, an improved coordination between devices including for scheduling of PUCCH and PUSCH.

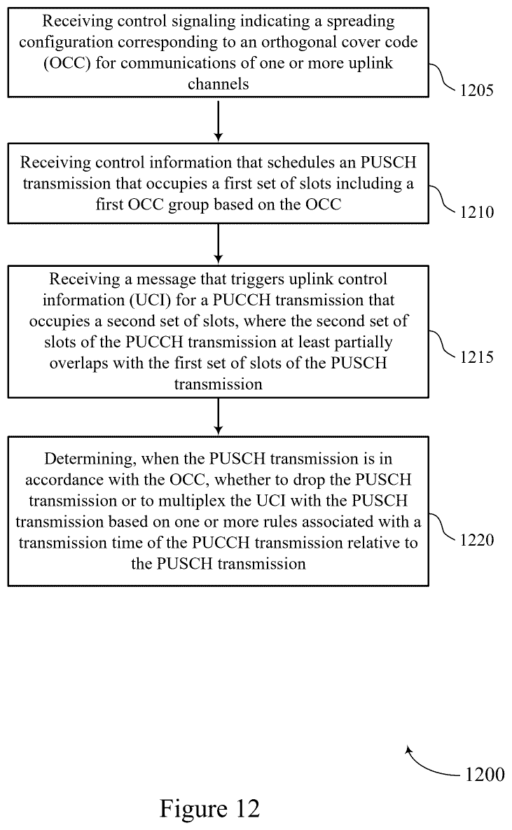

FIG. 12 shows an example of a method 1200 that supports techniques for handling overlapping uplink transmissions using OCC in accordance with various aspects of the present disclosure. Operations of the method 1200 may be performed by a UE or its components (such as using a processing system configured to cause the UE 115 to perform one or more of the operations) as described herein.

At 1205, the method may include receiving control signaling indicating a spreading configuration corresponding to an OCC for communications of one or more uplink channels. In some examples, aspects of the operations of 1205 may be performed by a control signaling component 825.

At 1210, the method may include receiving control information that schedules an PUSCH transmission that occupies a first set of slots including a first OCC group based on the OCC. In some examples, aspects of the operations of 1210 may be performed by a control signaling component 825.

At 1215, the method may include receiving a message that triggers UCI for a PUCCH transmission that occupies a second set of slots, where the second set of slots of the PUCCH transmission at least partially overlaps with the first set of slots of the PUSCH transmission. In some examples, aspects of the operations of 1215 may be performed by a control signaling component 825.

At 1220, the method may include determining, when the PUSCH transmission is in accordance with the OCC, whether to drop the first OCC group that includes the PUSCH transmission or to multiplex the UCI with the PUSCH transmission based on one or more rules associated with a transmission time of the PUCCH transmission relative to the PUSCH transmission. In some examples, aspects of the operations of 1220 may be performed by a PUCCH communication component 830.

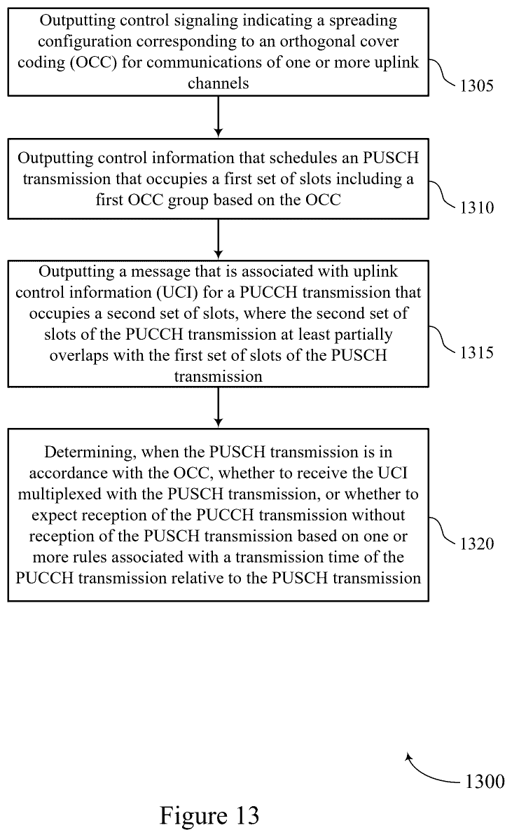

FIG. 13 shows an example of a method 1300 that supports techniques for handling overlapping uplink transmissions using OCC in accordance with various aspects of the present disclosure. Operations of the method 1300 may be performed by a network entity 105 or its components (such as using a processing system configured to cause the network entity to perform one or more operations) as described herein.

At 1305, the method may include outputting control signaling indicating a spreading configuration corresponding to an orthogonal cover coding (OCC) for communications of one or more uplink channels. In some examples, aspects of the operations of 1305 may be performed by a control signaling component 1025.

At 1310, the method may include outputting control information that schedules an PUSCH transmission that occupies a first set of slots including a first OCC group based on the OCC. In some examples, aspects of the operations of 1310 may be performed by a control signaling component 1025.

At 1315, the method may include outputting a message that is associated with UCI for a PUCCH transmission that occupies a second set of slots, where the second set of slots of the PUCCH transmission at least partially overlaps with the first set of slots of the PUSCH transmission. In some examples, aspects of the operations of 1315 may be performed by a control signaling component 1025.

At 1320, the method may include determining, when the PUSCH transmission is in accordance with the OCC, whether to receive the UCI multiplexed with the PUSCH transmission, or whether to expect reception of the PUCCH transmission without reception of the PUSCH transmission based on one or more rules associated with a transmission time of the PUCCH transmission relative to the PUSCH transmission. In some examples, aspects of the operations of 1320 may be performed by a PUCCH reception component 1030.

Implementation examples are described in the following numbered clauses:

Aspect 1: A method for wireless communications at a UE, comprising: receiving control signaling indicating a spreading configuration corresponding to an OCC for communications of one or more uplink channels; receiving control information that schedules an PUSCH transmission that occupies a first set of slots comprising a first OCC group based at least in part on the OCC; receiving a message that triggers UCI for a PUCCH transmission that occupies a second set of slots, wherein the second set of slots of the PUCCH transmission at least partially overlaps with the first set of slots of the PUSCH transmission; and determining, when the PUSCH transmission is in accordance with the OCC, whether to drop the first OCC group that includes the PUSCH transmission or to multiplex the UCI with the PUSCH transmission based at least in part on one or more rules associated with a transmission time of the PUCCH transmission relative to the PUSCH transmission.

Aspect 2: The method of aspect 1, wherein the message triggers at least two repetitions of the PUCCH transmission, the method further comprising: dropping the first OCC group that includes the PUSCH transmission based at least in part on the one or more rules, wherein the one or more rules indicate that the first OCC group that includes the PUSCH transmission is to be dropped when the PUCCH transmission is configured with the at least two repetitions and when the transmission time results in at least an initial PUCCH repetition being within a threshold duration of the PUSCH transmission; and transmitting the UCI via the at least two repetitions of the PUCCH transmission in accordance with the one or more rules and based at least in part on dropping the first OCC group that includes the PUSCH transmission.

Aspect 3: The method of any of aspects 1 through 2, wherein the message triggers the PUCCH transmission without repetition, and wherein the PUCCH transmission overlaps with a first slot of the first OCC group, the method further comprising: multiplexing the UCI of the PUCCH transmission with the PUSCH transmission in accordance with the OCC based at least in part on the one or more rules, wherein the one or more rules indicate that the UCI is to be multiplexed with the PUSCH transmission when the PUCCH transmission is configured without repetition and when the transmission time results in the PUCCH transmission being within a threshold duration of the first slot of the first OCC group.

Aspect 4: The method of aspect 3, further comprising: applying the OCC to the UCI and the PUSCH transmission using an OCC codeword that spreads respective data of the UCI and the PUSCH transmission over the first set of slots of the first OCC group.

Aspect 5: The method of any of aspects 1 through 4, wherein the message triggers the PUCCH transmission without repetition, and wherein the PUCCH transmission overlaps with a second slot of the first OCC group, the method further comprising: dropping the first OCC group that includes the PUSCH transmission based at least in part on the one or more rules, wherein the one or more rules indicate that the first OCC group that includes the PUSCH transmission is to be dropped when the PUCCH transmission is configured without repetitions and when the transmission time results in the PUCCH transmission being within a threshold duration of the PUSCH transmission; and transmitting the UCI via the PUCCH transmission in accordance with the one or more rules and based at least in part on dropping the first OCC group that includes the PUSCH transmission.

Aspect 6: The method of any of aspects 1 through 5, wherein the message triggers the PUCCH transmission without repetition, and wherein the PUCCH transmission overlaps with a second slot that is different from a first slot of the first OCC group, the method further comprising: multiplexing the UCI of the PUCCH transmission with the PUSCH transmission of the first OCC group based at least in part on the one or more rules, wherein the one or more rules indicate that the UCI is to be multiplexed with the PUSCH when the PUCCH transmission is configured without repetition and when the transmission time results in the PUCCH transmission being within a threshold duration of the second slot of the first OCC group.

Aspect 7: The method of aspect 6, further comprising: applying the OCC to the UCI and the PUSCH transmission using an OCC codeword that spreads respective data of the UCI and the PUSCH transmission over the first set of slots of the first OCC group.

Aspect 8: The method of any of aspects 1 through 7, wherein the message triggers the PUCCH transmission without repetition, wherein the PUCCH transmission overlaps with at least one additional OCC group, the first OCC group, or both, that occurs after the first OCC group, the method further comprising: dropping the at least one additional OCC group, the first OCC group, or both, that include the PUSCH transmission based at least in part on the one or more rules, wherein the one or more rules indicate that the at least one additional OCC group, the first OCC group, or both, are to be dropped when the PUCCH transmission is configured without repetition and when the transmission time results in the PUCCH transmission being within a threshold duration of the message; and transmitting the UCI via the PUCCH transmission in accordance with the one or more rules and based at least in part on dropping the at least one additional OCC group, the first OCC group, or both, that include the PUSCH transmission.

Aspect 9: The method of any of aspects 1 through 8, wherein the message triggers the PUCCH transmission without repetition, wherein the PUCCH transmission overlaps with at least one additional OCC group, the first OCC group, or both, occurring after the first OCC group, the method further comprising: dropping the at least one additional OCC group, the first OCC group, or both, that include the PUSCH transmission based at least in part on the one or more rules, wherein the one or more rules indicate that the at least one additional OCC group, the first OCC group, or both, are to be dropped when the PUCCH transmission is configured without repetition and when the transmission time results in the first OCC group including the PUSCH transmission is within a threshold duration of the message; and transmitting the UCI via the PUCCH transmission in accordance with the one or more rules and based at least in part on dropping the at least one additional OCC group, the first OCC group, or both, that include the PUSCH transmission.

Aspect 10: The method of any of aspects 1 through 9, wherein during transmission of the PUSCH transmission the UE receives the message that triggers the UCI of the PUCCH transmission, the method further comprising: dropping one or more OCC groups that include the PUSCH transmission based at least in part on reception of the message; dropping the PUCCH transmission based at least in part on reception of the message during transmission of the PUSCH transmission; or dropping both the PUCCH transmission and the one or more OCC groups that include the PUSCH transmission.

Aspect 11: The method of any of aspects 1 through 10, further comprising: transmitting one or more UE capability messages indicative of an OCC capability of the UE, a phase coherence capability of the UE, a capability of the UE to support transmission of PUSCH and PUCCH in accordance with the transmission time, or any combination thereof.

Aspect 12: The method of any of aspects 1 through 11, further comprising: receiving control signaling that indicates a multiplexing order associated with the OCC, an OCC codeword associated with the OCC, or any combination thereof.

Aspect 13: The method of any of aspects 1 through 12, wherein the message includes an PDSCH transmission, a DCI message, or both, and the transmission time is based at least in part on a time duration between the PUCCH transmission and the message.

Aspect 14: The method of any of aspects 1 through 13, wherein the PUSCH transmission and the PUCCH transmission have a same transmission priority.

Aspect 15: The method of any of aspects 1 through 14, wherein the transmission time comprises a processing time that occurs between reception of the message and the PUCCH transmission, a processing time between reception of the control message and transmission of the PUSCH transmission, or both, and determining whether to drop the first OCC group that includes the PUSCH transmission or to multiplex the UCI with the PUSCH transmission is further based at least in part on whether the transmission time exceeds a threshold duration.

Aspect 16: A method for wireless communications a network entity, comprising: outputting control signaling indicating a spreading configuration corresponding to an orthogonal cover coding (OCC) for communications of one or more uplink channels; outputting control information that schedules an PUSCH transmission that occupies a first set of slots comprising a first OCC group based at least in part on the OCC; outputting a message that is associated with UCI for a PUCCH transmission that occupies a second set of slots, wherein the second set of slots of the PUCCH transmission at least partially overlaps with the first set of slots of the PUSCH transmission; and determining, when the PUSCH transmission is in accordance with the OCC, whether to receive the UCI multiplexed with the PUSCH transmission, or whether to expect reception of the PUCCH transmission without reception of the PUSCH transmission based at least in part on one or more rules associated with a transmission time of the PUCCH transmission relative to the PUSCH transmission.

Aspect 17: The method of aspect 16, wherein the message is associated with at least two repetitions of the PUCCH transmission, the method further comprising: obtaining the UCI via the at least two repetitions of the PUCCH transmission in accordance with the one or more rules, wherein the one or more rules indicate that the first OCC group that includes the PUSCH transmission is to be dropped when the PUCCH transmission is configured with the at least two repetitions and when the transmission time results in at least an initial PUCCH repetition being within a threshold duration of the PUSCH transmission.

Aspect 18: The method of any of aspects 16 through 17, wherein the message is associated with the PUCCH transmission without repetition, wherein the PUCCH transmission overlaps with a first slot of the first set of slots of the PUSCH transmission, the method further comprising: obtaining the UCI multiplexed with the PUSCH transmission in accordance with the OCC based at least in part on the one or more rules, wherein the one or more rules indicate the UCI is to be multiplexed with the PUSCH transmission when the PUCCH transmission is configured without repetition and when the transmission time results in the PUCCH transmission being within a threshold duration of the first slot of the first set of slots of the PUSCH transmission.

Aspect 19: The method of any of aspects 16 through 18, wherein the message is associated with the PUCCH transmission without repetition, wherein the PUCCH transmission overlaps with a second slot of the first set of slots of the PUSCH transmission, the method further comprising: obtaining the UCI via the PUCCH transmission in accordance with the one or more rules, wherein the one or more rules indicate that the first OCC group that includes the PUSCH transmission is to be dropped when the PUCCH transmission is configured without repetitions and when the transmission time results in the PUCCH transmission being within a threshold duration of the PUSCH transmission.

Aspect 20: The method of any of aspects 16 through 19, wherein the message is associated with the PUCCH transmission without repetition, wherein the PUCCH overlaps with a second slot that is different from a first slot of the first slot of the first OCC group, the method further comprising: obtaining the UCI multiplexed with the PUSCH transmission in accordance with the OCC of the first OCC group based at least in part on the one or more rules, wherein the one or more rules indicate that the UCI is to be multiplexed with the PUSCH when the PUCCH transmission is configured without repetition and when the transmission time results in the PUCCH transmission being within a threshold duration of the second slot of the first OCC group.

Aspect 21: The method of any of aspects 16 through 20, wherein the message is associated with the PUCCH transmission without repetition, and wherein the PUCCH transmission overlaps with at least one additional OCC group, the first OCC group, or both, that occurs after the first OCC group, the method further comprising: obtaining the UCI via the PUCCH transmission in accordance with the one or more rules, wherein the one or more rules indicate that the PUSCH transmission in the at least one additional OCC group, the first OCC group, or both, are to be dropped when the PUCCH transmission is configured without repetition and when the transmission time results in the PUCCH transmission being within a threshold duration of the message.

Aspect 22: The method of any of aspects 16 through 21, wherein the message is associated with the PUCCH transmission without repetition, wherein the PUCCH transmission overlaps with at least one additional OCC group, the first OCC group, or both, occurring after the first OCC group, the method further comprising: obtaining the UCI via the PUCCH transmission based at least in part on the one or more rules, wherein the one or more rules indicate that the at least one additional OCC group, the first OCC group, or both, are to be dropped when the PUCCH transmission is configured without repetition and when the transmission time results in the first OCC group including the PUSCH transmission is within a threshold duration of the message.

Aspect 23: The method of any of aspects 16 through 22, further comprising: modifying a first scheduling of the message associated with the UCI of the PUCCH transmission based at least in part on the first scheduling indicating that the message is at least partially overlapping with the PUSCH transmission.

Aspect 24: The method of any of aspects 16 through 23, further comprising: obtaining one or more UE capability messages indicative of an OCC capability of the UE, a phase coherence capability of the UE, a capability of the UE to support transmission of PUSCH and PUCCH in accordance with the transmission time, or any combination thereof.

Aspect 25: The method of any of aspects 16 through 24, further comprising: outputting control signaling that indicates a multiplexing order associated with the OCC, an OCC codeword associated with the OCC, or any combination thereof.

Aspect 26: The method of any of aspects 16 through 25, wherein the message includes an PDSCH transmission, a DCI message, or both, and the transmission time is based at least in part on a time duration between the PUCCH transmission and the message.

Aspect 27: The method of any of aspects 16 through 26, wherein the PUSCH transmission and the PUCCH transmission have a same transmission priority.

Aspect 28: The method of any of aspects 16 through 27, wherein the transmission time comprises a processing time that occurs between reception of the message and the PUCCH transmission, a processing time between reception of the control message and transmission of the PUSCH transmission, or both, and determining whether to drop the first OCC group that includes the PUSCH transmission or to multiplex the UCI with the PUSCH transmission is further based at least in part on whether the transmission time exceeds a threshold duration.

Aspect 29: A UE for wireless communications, comprising a processing system that includes processor circuitry and memory circuitry that stores code, the processing system configured to cause the UE to perform a method of any of aspects 1 through 15.

Aspect 30: A UE for wireless communications, comprising at least one means for performing a method of any of aspects 1 through 15.

Aspect 31: A non-transitory computer-readable medium storing code for wireless communications, the code comprising instructions executable by one or more processors to perform a method of any of aspects 1 through 15.

Aspect 32: A network entity for wireless communications, comprising a processing system that includes processor circuitry and memory circuitry that stores code, the processing system configured to cause the network entity to perform a method of any of aspects 16 through 28.

Aspect 33: A network entity for wireless communications, comprising at least one means for performing a method of any of aspects 16 through 28.

Aspect 34: A non-transitory computer-readable medium storing code for wireless communications a network entity, the code comprising instructions executable by one or more processors to perform a method of any of aspects 16 through 28.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software components, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
receive control signaling indicating a spreading configuration corresponding to an orthogonal cover code (OCC) for communications of one or more uplink channels;
receive control information that schedules a physical uplink shared channel (PUSCH) transmission that occupies a first set of slots comprising a first OCC group based at least in part on the OCC;
receive a message that triggers uplink control information (UCI) for a physical uplink control channel (PUCCH) transmission that occupies a second set of slots, wherein the second set of slots of the PUCCH transmission at least partially overlaps with the first set of slots of the PUSCH transmission; and
determine, when the PUSCH transmission is in accordance with the OCC, whether to drop the first OCC group that includes the PUSCH transmission or to multiplex the UCI with the PUSCH transmission based at least in part on one or more rules associated with a transmission time of the PUCCH transmission relative to the PUSCH transmission.

2. The UE of claim 1, wherein the message triggers at least two repetitions of the PUCCH transmission, and the processing system is further configured to cause the UE to:
drop the first OCC group that includes the PUSCH transmission based at least in part on the one or more rules, wherein the one or more rules indicate that the first OCC group that includes the PUSCH transmission is to be dropped when the PUCCH transmission is configured with the at least two repetitions and when the transmission time results in at least an initial PUCCH repetition being within a threshold duration of the PUSCH transmission; and
transmit the UCI via the at least two repetitions of the PUCCH transmission in accordance with the one or more rules and based at least in part on dropping the first OCC group that includes the PUSCH transmission.

3. The UE of claim 1, wherein the message triggers the PUCCH transmission without repetition, and wherein the PUCCH transmission overlaps with a first slot of the first OCC group, and the processing system is further configured to cause the UE to:
multiplex the UCI of the PUCCH transmission with the PUSCH transmission in accordance with the OCC based at least in part on the one or more rules, wherein the one or more rules indicate that the UCI is to be multiplexed with the PUSCH transmission when the PUCCH transmission is configured without repetition and when the transmission time results in the PUCCH transmission being within a threshold duration of the first slot of the first OCC group.

4. The UE of claim 3, wherein the processing system is further configured to cause the UE to:
apply the OCC to the UCI and the PUSCH transmission using an OCC codeword that spreads respective data of the UCI and the PUSCH transmission over the first set of slots of the first OCC group.

5. The UE of claim 1, wherein the message triggers the PUCCH transmission without repetition, and wherein the PUCCH transmission overlaps with a second slot of the first OCC group, and the processing system is further configured to cause the UE to:
drop the first OCC group that includes the PUSCH transmission based at least in part on the one or more rules, wherein the one or more rules indicate that the first OCC group that includes the PUSCH transmission is to be dropped when the PUCCH transmission is configured without repetitions and when the transmission time results in the PUCCH transmission being within a threshold duration of the PUSCH transmission; and
transmit the UCI via the PUCCH transmission in accordance with the one or more rules and based at least in part on dropping the first OCC group that includes the PUSCH transmission.

6. The UE of claim 1, wherein the message triggers the PUCCH transmission without repetition, and wherein the PUCCH transmission overlaps with a second slot that is different from a first slot of the first OCC group, and the processing system is further configured to cause the UE to:
multiplex the UCI of the PUCCH transmission with the PUSCH transmission of the first OCC group based at least in part on the one or more rules, wherein the one or more rules indicate that the UCI is to be multiplexed with the PUSCH when the PUCCH transmission is configured without repetition and when the transmission time results in the PUCCH transmission being within a threshold duration of the second slot of the first OCC group.

7. The UE of claim 6, wherein the processing system is further configured to cause the UE to:
apply the OCC to the UCI and the PUSCH transmission using an OCC codeword that spreads respective data of the UCI and the PUSCH transmission over the first set of slots of the first OCC group.

8. The UE of claim 1, wherein the message triggers the PUCCH transmission without repetition, wherein the PUCCH transmission overlaps with at least one additional OCC group that occurs after the first OCC group, and the processing system is further configured to cause the UE to:
drop the at least one additional OCC group, the first OCC group, or both, that include the PUSCH transmission based at least in part on the one or more rules, wherein the one or more rules indicate that the at least one additional OCC group, the first OCC group, or both, are to be dropped when the PUCCH transmission is configured without repetition and when the transmission time results in the PUCCH transmission being within a threshold duration of the message; and
transmit the UCI via the PUCCH transmission in accordance with the one or more rules and based at least in part on dropping the at least one additional OCC group, the first OCC group, or both, that include the PUSCH transmission.

9. The UE of claim 1, wherein the message triggers the PUCCH transmission without repetition, wherein the PUCCH transmission overlaps with at least one additional OCC group occurring after the first OCC group, and the processing system is further configured to cause the UE to:
drop the at least one additional OCC group, the first OCC group, or both, that include the PUSCH transmission based at least in part on the one or more rules, wherein the one or more rules indicate that the at least one additional OCC group, the first OCC group, or both, are to be dropped when the PUCCH transmission is configured without repetition and when the transmission time results in the first OCC group including the PUSCH transmission is within a threshold duration of the message; and
transmit the UCI via the PUCCH transmission in accordance with the one or more rules and based at least in part on dropping the at least one additional OCC group, the first OCC group, or both, that include the PUSCH transmission.

10. The UE of claim 1, wherein during transmission of the PUSCH transmission, the UE receives the message that triggers the UCI of the PUCCH transmission, and the processing system is further configured to cause the UE to:
drop one or more OCC groups that include the PUSCH transmission based at least in part on reception of the message;
drop the PUCCH transmission based at least in part on reception of the message during transmission of the PUSCH transmission; or
drop both the PUCCH transmission and the one or more OCC groups that include the PUSCH transmission.

11. The UE of claim 1, wherein the processing system is further configured to cause the UE to:
transmit one or more UE capability messages indicative of an OCC capability of the UE, a phase coherence capability of the UE, a capability of the UE to support transmission of PUSCH and PUCCH in accordance with the transmission time, or any combination thereof.

12. The UE of claim 1, wherein the processing system is further configured to cause the UE to:
receive control signaling that indicates a multiplexing order associated with the OCC, an OCC codeword associated with the OCC, or any combination thereof.

13. The UE of claim 1, wherein:
the message includes a physical downlink shared channel (PDSCH) transmission, a downlink control information (DCI) message, or both, and
the transmission time is based at least in part on a time duration between the PUCCH transmission and the message.

14. The UE of claim 1, wherein the PUSCH transmission and the PUCCH transmission have a same transmission priority.

15. The UE of claim 1, wherein the transmission time comprises a processing time that occurs between reception of the message and the PUCCH transmission, a processing time between reception of the control information and transmission of the PUSCH transmission, or both, and determining whether to drop the first OCC group that includes the PUSCH transmission or to multiplex the UCI with the PUSCH transmission is further based at least in part on whether the transmission time exceeds a threshold duration.

16. A network entity, comprising:
a processing system that includes processor circuitry and memory circuitry that stores code, the processing system configured to cause the network entity to:
output control signaling indicating a spreading configuration corresponding to an orthogonal cover coding (OCC) for communications of one or more uplink channels;
output control information that schedules a physical uplink shared channel (PUSCH) transmission that occupies a first set of slots comprising a first OCC group based at least in part on the OCC;
output a message that is associated with uplink control information (UCI) for a physical uplink control channel (PUCCH) transmission that occupies a second set of slots, wherein the second set of slots of the PUCCH transmission at least partially overlaps with the first set of slots of the PUSCH transmission; and
determine, when the PUSCH transmission is in accordance with the OCC, whether to receive the UCI multiplexed with the PUSCH transmission, or whether to expect reception of the PUCCH transmission without reception of the PUSCH transmission based at least in part on one or more rules associated with a transmission time of the PUCCH transmission relative to the PUSCH transmission.

17. The network entity of claim 16, wherein the message is associated with at least two repetitions of the PUCCH transmission, and the processing system is further configured to cause the network entity to:
obtain the UCI via the at least two repetitions of the PUCCH transmission in accordance with the one or more rules, wherein the one or more rules indicate that the first OCC group that includes the PUSCH transmission is to be dropped when the PUCCH transmission is configured with the at least two repetitions and when the transmission time results in at least an initial PUCCH repetition being within a threshold duration of the PUSCH transmission.

18. The network entity of claim 16, wherein the message is associated with the PUCCH transmission without repetition, wherein the PUCCH transmission overlaps with a first slot of the first set of slots of the PUSCH transmission, and the processing system is further configured to cause the network entity to:
obtain the UCI multiplexed with the PUSCH transmission in accordance with the OCC based at least in part on the one or more rules, wherein the one or more rules indicate the UCI is to be multiplexed with the PUSCH transmission when the PUCCH transmission is configured without repetition and when the transmission time results in the PUCCH transmission being within a threshold duration of the first slot of the first set of slots of the PUSCH transmission.

19. The network entity of claim 16, wherein the message is associated with the PUCCH transmission without repetition, wherein the PUCCH transmission overlaps with a second slot of the first set of slots of the PUSCH transmission, and the processing system is further configured to cause the network entity to:
obtain the UCI via the PUCCH transmission in accordance with the one or more rules, wherein the one or more rules indicate that the first OCC group that includes the PUSCH transmission is to be dropped when the PUCCH transmission is configured without repetitions and when the transmission time results in the PUCCH transmission being within a threshold duration of the PUSCH transmission.

20. A method for wireless communications at a user equipment (UE), comprising:
receiving control signaling indicating a spreading configuration corresponding to an orthogonal cover code (OCC) for communications of one or more uplink channels;
receiving control information that schedules a physical uplink shared channel (PUSCH) transmission that occupies a first set of slots comprising a first OCC group based at least in part on the OCC;
receiving a message that triggers uplink control information (UCI) for a physical uplink control channel (PUCCH) transmission that occupies a second set of slots, wherein the second set of slots of the PUCCH transmission at least partially overlaps with the first set of slots of the PUSCH transmission; and
determining, when the PUSCH transmission is in accordance with the OCC, whether to drop the first OCC group that includes the PUSCH transmission or to multiplex the UCI with the PUSCH transmission based at least in part on one or more rules associated with a transmission time of the PUCCH transmission relative to the PUSCH transmission.
